(19) United States
(12) Patent Application Publication
(10) Pub. No.: US 2025/0097946 A1
(43) Pub. Date: Mar. 20, 2025

(54) COOPERATIVE HYBRID AUTOMATIC REPEAT REQUEST-ACKNOWLEDGEMENT (HARQ-ACK) FEEDBACK REPORTING

(71) Applicant: QUALCOMM Incorporated, San Diego, CA (US)

(72) Inventors: Marwen ZORGUI, San Diego, CA (US); Ahmed Attia ABOTABL, San Diego, CA (US); Diana MAAMARI, San Diego, CA (US)

(21) Appl. No.: 18/466,956

(22) Filed: Sep. 14, 2023

(51) Int. Cl. H04W 72/21; H04W 72/044

(52) U.S. Cl. CPC H04W 72/21; H04W 72/044

(57) ABSTRACT

Methods, systems, and devices for wireless communications are described. For example, the described techniques enable user equipment (UEs) to perform feedback reporting. A first UE may communicate an indication that it is in a UE group associated with uplink feedback resource sharing among UEs in the UE group. The first UE may then receive one or more messages indicating sets of uplink feedback resources associated with the first UE and one or more other UEs in the UE group, the uplink feedback resources being configured for uplink feedback resources sharing. The UEs within the UE group may support shared feedback resources so that a UE may access and utilize any quantity of feedback resources associated with any UE that belongs to the same cooperative group. The first UE may select a resource from the sets of uplink feedback resources and may communicate uplink feedback based on the selection.

### FIELD OF TECHNOLOGY

The following relates to wireless communications, including cooperative hybrid automatic repeat request-acknowledgement (HARQ-ACK) feedback reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cooperative hybrid automatic repeat request-acknowledgement (HARQ-ACK) feedback reporting. For example, the described techniques enable user equipment (UEs) to perform feedback reporting within a UE group (such as a configured UE group) that may be configured, or otherwise determined, by a network entity, or by one or more UEs within the group. The UEs within the UE group may support shared feedback resources such that any UE in the UE group may access and utilize feedback resources, even if the feedback resources are associated with or configured for another UE within the UE group, so long as that UE belongs to the same cooperative group. For example, a UE may transmit or receive an indication that it is part of a UE group (e.g., a UE cooperative group, a cooperative group) associated with the shared feedback resources. The UE may receive an indication of a set of uplink feedback resources allocated for itself and an indication of one or more other sets of uplink feedback resources allocated for one or more other UEs in the UE group. The UE may then transmit one or more feedback messages via feedback resources associated with any UE of the UE group, or the UE may transmit the one or more feedback messages to the one or more other UEs in the UE group to relay to the network via the shared feedback resources.

A method for wireless communications by a first UE is described. The method may include communicating an indication that the first UE is in a UE group associated with uplink feedback resource sharing, the UE group including a set of multiple UEs including the first UE and a second UE, receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group, and transmitting one or more feedback messages associated with the UE group based on a selection of a set of shared resources from the first set of uplink feedback resources or the second set of uplink feedback resources.

An apparatus for wireless communications at a first UE is described. The apparatus may include one or more processors and one or more instructions stored in one or more memories that are executable by the one or more processors, individually or collectively, to cause the apparatus to communicate an indication that the first UE is in a UE group associated with uplink feedback resource sharing, the UE group including a set of multiple UEs including the first UE and a second UE, receive one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group, and transmit one or more feedback messages associated with the UE group based on a selection of a set of shared resources from the first set of uplink feedback resources or the second set of uplink feedback resources.

A first UE for wireless communications is described. The first UE may include means for communicating an indication that the first UE is in a UE group associated with uplink feedback resource sharing, the UE group including a set of multiple UEs including the first UE and a second UE, means for receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group, and means for transmitting one or more feedback messages associated with the UE group based on a selection of a set of shared resources from the first set of uplink feedback resources or the second set of uplink feedback resources.

A non-transitory computer-readable medium storing code for wireless communications is described. The code may include instructions executable by a processor to communicate an indication that the first UE is in a UE group associated with uplink feedback resource sharing, the UE group including a set of multiple UEs including the first UE and a second UE, receive one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group, and transmit one or more feedback messages associated with the UE group based on a selection of a set of shared resources from the first set of uplink feedback resources or the second set of uplink feedback resources.

In some examples of the method, apparatus, first UEs, and non-transitory computer-readable medium described herein, transmitting the one or more feedback messages may include operations, features, means, or instructions for transmitting the one or more feedback messages via the second set of uplink feedback resources allocated for the second UE based on the first UE and the second UE both being in the UE group.

Some examples of the method, apparatus, first UEs, and non-transitory computer-readable medium described herein may further include operations, features, means, or instructions for receiving, from the second UE, a second feedback message including feedback associated with the second UE, where the one or more feedback messages associated with the cooperative group UE include the feedback associated with the second UE.

In some examples of the method, apparatus, first UEs, and non-transitory computer-readable medium described herein, transmitting the one or more feedback messages may include operations, features, means, or instructions for transmitting the one or more feedback messages to the second UE, where the one or more feedback messages include feedback associated with the first UE.

In some examples of the method, apparatus, first UEs, and non-transitory computer-readable medium described herein, receiving the one or more messages may include operations, features, means, or instructions for receiving an indication of a set of multiple sets of feedback resources including respective resources for each of the set of multiple UEs of the UE group, where the set of multiple sets of feedback resources may be configured for the uplink feedback resource sharing.

Some examples of the method, apparatus, first UEs, and non-transitory computer-readable medium described herein may further include operations, features, means, or instructions for receiving, from the second UE, an indication of the second set of uplink feedback resources that may be configured for the uplink feedback resource sharing for the first UE and the second UE and transmitting, to a network entity, an indication of the uplink feedback resource sharing for the set of multiple UEs of the UE group.

In some examples of the method, apparatus, first UEs, and non-transitory computer-readable medium described herein, communicating the indication that the first UE may be in the UE group may include operations, features, means, or instructions for receiving, from one or more UEs of the set of multiple UEs of the UE group, one or more UE identifiers and transmitting, to a network entity, an indication of one or more UE identifiers associated with the set of multiple UEs in the UE group.

Some examples of the method, apparatus, first UEs, and non-transitory computer-readable medium described herein may further include operations, features, means, or instructions for receiving, via one or more control messages, an indication of activation or deactivation of the uplink feedback resource sharing for the set of multiple UEs in the UE group, where the one or more control messages include one or more radio resource control (RRC) messages, one or more medium access control-control elements (MAC-CEs), one or more downlink control information (DCI) messages, or any combination thereof.

In some examples of the method, apparatus, first UEs, and non-transitory computer-readable medium described herein, transmitting the one or more feedback messages may include operations, features, means, or instructions for transmitting a first feedback message of the one or more feedback messages associated with the first UE via a first feedback resource and transmitting a second feedback message of the one or more feedback messages associated with the second UE via the first feedback resource or via a second feedback resource based on a priority of the second feedback message.

In some examples of the method, apparatus, first UEs, and non-transitory computer-readable medium described herein, transmitting the one or more feedback messages may include operations, features, means, or instructions for transmitting the one or more feedback messages as a joint feedback codeword that indicates first feedback associated with the first UE and second feedback associated with the second UE.

In some examples of the method, apparatus, first UEs, and non-transitory computer-readable medium described herein, transmitting the one or more feedback messages may include operations, features, means, or instructions for transmitting the one or more feedback messages via the first set of uplink feedback resources based on the first set of uplink feedback resources occurring a threshold duration of time before the second set of uplink feedback resources or via the second set of uplink feedback resources based on the second set of uplink feedback resources occurring the threshold duration of time before the second set of uplink feedback resources.

In some examples of the method, apparatus, first UEs, and non-transitory computer-readable medium described herein, each UE of the set of multiple UEs may have a capability to share uplink feedback resources to assist uplink feedback reporting based on each UE being in the UE group.

In some examples of the method, apparatus, first UEs, and non-transitory computer-readable medium described herein, the capability may be configured per cell configuration, per bandwidth part configuration, or both.

Some examples of the method, apparatus, first UEs, and non-transitory computer-readable medium described herein may further include operations, features, means, or instructions for receiving an indication of a third set of uplink feedback resources allocated for a third UE, where the third set of uplink feedback resources may be configured for the uplink feedback resource sharing for UEs based on the first UE, the second UE, and the third UE being in the UE group, where the one or more feedback messages may be transmitted via the third set of uplink feedback resources based on the third set of uplink feedback resources occurring before both the first set of uplink feedback resources and the second set of uplink feedback resources.

Some examples of the method, apparatus, first UEs, and non-transitory computer-readable medium described herein may further include operations, features, means, or instructions for receiving an indication of one or more resources of the first set of uplink feedback resources or the second set of uplink feedback resources, the one or more resources configured for the uplink feedback resource sharing.

A method for wireless communications by a network entity is described. The method may include communicating an indication that a first UE is associated with a UE group associated with uplink feedback resource sharing, the UE group a set of multiple UEs including the first UE and a second UE, transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group, and receiving one or more feedback messages associated with the UE group based on the uplink feedback resource sharing.

A apparatus for wireless communications at a network entity is described. The apparatus may include one or more processors and one or more instructions stored in one or more memories that are executable by the one or more processors, individually or collectively, to cause the apparatus to communicate an indication that a first UE is associated with a UE group associated with uplink feedback resource sharing, the UE group a set of multiple UEs including the first UE and a second UE, transmit one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group, and receive one or more feedback messages associated with the UE group based on the uplink feedback resource sharing.

A network entity for wireless communications is described. The network entity may include means for communicating an indication that a first UE is associated with a UE group associated with uplink feedback resource sharing, the UE group a set of multiple UEs including the first UE and a second UE, means for transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group, and means for receiving one or more feedback messages associated with the UE group based on the uplink feedback resource sharing.

A non-transitory computer-readable medium storing code for wireless communications is described. The code may include instructions executable by a processor to communicate an indication that a first UE is associated with a UE group associated with uplink feedback resource sharing, the UE group a set of multiple UEs including the first UE and a second UE, transmit one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group, and receive one or more feedback messages associated with the UE group based on the uplink feedback resource sharing.

Some examples of the method, apparatus, network entities, and non-transitory computer-readable medium described herein may further include operations, features, means, or instructions for receiving, from the first UE, a second feedback message including feedback associated with the second UE, where the one or more feedback messages associated with the UE group include the feedback associated with the second UE.

In some examples of the method, apparatus, network entities, and non-transitory computer-readable medium described herein, receiving the one or more feedback messages may include operations, features, means, or instructions for receiving, from the first UE and via the first set of uplink feedback resources allocated for the first UE, the one or more feedback messages associated with the second UE.

In some examples of the method, apparatus, network entities, and non-transitory computer-readable medium described herein, transmitting the one or more messages may include operations, features, means, or instructions for transmitting an indication of a set of multiple sets of feedback resources including respective resources for each of the set of multiple UEs of the UE group, where the set of multiple sets of feedback resources may be configured for the uplink feedback resource sharing.

Some examples of the method, apparatus, network entities, and non-transitory computer-readable medium described herein may further include operations, features, means, or instructions for receiving an indication of the uplink feedback resource sharing for the set of multiple UEs of the UE group.

In some examples of the method, apparatus, network entities, and non-transitory computer-readable medium described herein, communicating the indication that the first UE may be in the UE group may include operations, features, means, or instructions for receiving one or more UE identifiers associated with the set of multiple UEs in the UE group.

Some examples of the method, apparatus, network entities, and non-transitory computer-readable medium described herein may further include operations, features, means, or instructions for transmitting, via one or more control messages, an indication of activation or deactivation of the uplink feedback resource sharing for the set of multiple UEs in the UE group, where the one or more control messages include one or more RRC messages, one or more MAC-CEs, one or more DCI messages, or any combination thereof.

In some examples of the method, apparatus, network entities, and non-transitory computer-readable medium described herein, receiving the one or more feedback messages may include operations, features, means, or instructions for receiving a first feedback message of the one or more feedback messages associated with the first UE via a first feedback resource and receiving a second feedback message of the one or more feedback messages associated with the second UE via the first feedback resource or via a second feedback resource based on a priority of the second feedback message.

In some examples of the method, apparatus, network entities, and non-transitory computer-readable medium described herein, receiving the one or more feedback messages may include operations, features, means, or instructions for receiving the one or more feedback messages as a joint feedback codeword that indicates first feedback associated with the first UE and second feedback associated with the second UE.

In some examples of the method, apparatus, network entities, and non-transitory computer-readable medium described herein, receiving the one or more feedback messages may include operations, features, means, or instructions for receiving the one or more feedback messages based on each UE of the set of multiple UEs having a capability to share uplink feedback resources to assist uplink feedback reporting based on being part of the UE group.

In some examples of the method, apparatus, network entities, and non-transitory computer-readable medium described herein, the capability may be configured per cell configuration, per bandwidth part configuration, or both.

Some examples of the method, apparatus, network entities, and non-transitory computer-readable medium described herein may further include operations, features, means, or instructions for transmitting an indication of a third set of uplink feedback resources allocated for a third UE, where the third set of uplink feedback resources may be configured for the uplink feedback resource sharing for UEs based on the first UE, the second UE, and the third UE being in the UE group, where and the one or more feedback messages may be transmitted via the third set of uplink feedback resources based on the third set of uplink feedback resources occurring before both the first set of uplink feedback resources and the second set of uplink feedback resources.

Some examples of the method, apparatus, network entities, and non-transitory computer-readable medium described herein may further include operations, features, means, or instructions for transmitting an indication of one or more resources of the first set of uplink feedback resources or the second set of uplink feedback resources, the one or more resources configured for the uplink feedback resource sharing.

### BRIEF DESCRIPTION OF THE DRAWINGS

FIGS. 1, 2, 3, and 4 show examples of wireless communications systems that support cooperative hybrid-automatic repeat request-acknowledgement (HARQ-ACK) feedback reporting in accordance with one or more aspects of the present disclosure.

FIG. 5 shows an example of a process flow that supports cooperative HARQ-ACK feedback reporting in accordance with one or more aspects of the present disclosure.

FIGS. 6 and 7 show block diagrams of devices that support cooperative HARQ-ACK feedback reporting in accordance with one or more aspects of the present disclosure.

FIG. 8 shows a block diagram of a communications manager that supports cooperative HARQ-ACK feedback reporting in accordance with one or more aspects of the present disclosure.

FIG. 9 shows a diagram of a system including a device that supports cooperative HARQ-ACK feedback reporting in accordance with one or more aspects of the present disclosure.

FIGS. 10 and 11 show block diagrams of devices that support cooperative HARQ-ACK feedback reporting in accordance with one or more aspects of the present disclosure.

FIG. 12 shows a block diagram of a communications manager that supports cooperative HARQ-ACK feedback reporting in accordance with one or more aspects of the present disclosure.

FIG. 13 shows a diagram of a system including a device that supports cooperative HARQ-ACK feedback reporting in accordance with one or more aspects of the present disclosure.

FIGS. 14 through 18 show flowcharts illustrating methods that support cooperative HARQ-ACK feedback reporting in accordance with one or more aspects of the present disclosure.

### DETAILED DESCRIPTION

Some wireless communications systems may support communications for quantity of user equipment (UEs) (e.g., a threshold quantity of UEs) within a coverage area and multiple UEs may aggregated or grouped together to save device power and reduce system overhead. In some grouped UE deployments, the UEs may report different types of device measurements (such as channel state reporting, positioning and mobility measurements, or the like) per-UE group, for example, in the case that the UEs may be within a threshold range of one another and may therefore have the same or similar communication properties, metrics, or conditions. In some cases, the UEs in a UE group may also perform the same (or similar) beam management procedures and may share the same physical layer or medium access control layer procedures to save power and system overhead.

The UEs within the UE group may also monitor channel quality and send feedback to the network as part of ongoing communications management. In some cases, however, a network entity may assign each UE respective sets of feedback resources, such that an individual UE may use its assigned set of feedback resources to send hybrid-automatic repeat request-acknowledgement (HARQ-ACK) feedback messaging to the network. Such individually assigned feedback resources, however, may not be optimized for the group-UE deployment.

To reduce feedback latency and increase the efficiency and flexibility in which UEs perform feedback reporting within a UE group, the UEs within the UE group may support shared feedback resources so that a UE may access and utilize any quantity of feedback resources associated with any UE that belongs to the same cooperative group. For example, the network entity may assign a first UE a first set of feedback resources within a cooperative UE group and the network entity may assign a second UE a second set of feedback resources within the same cooperative UE group. Then, based on various factors such as latency, feedback priority, and resource availability, the first UE may use the second set of feedback resources (associated with the second UE) to transmit HARQ feedback to the network, for example, at times where the second set of resources occur prior to the first set of resources. Additionally, or alternatively, the first UE may transmit its own feedback to the second UE, and the second UE may relay the feedback for the first UE to the network using the second set of resources.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to cooperative HARQ-ACK feedback reporting.

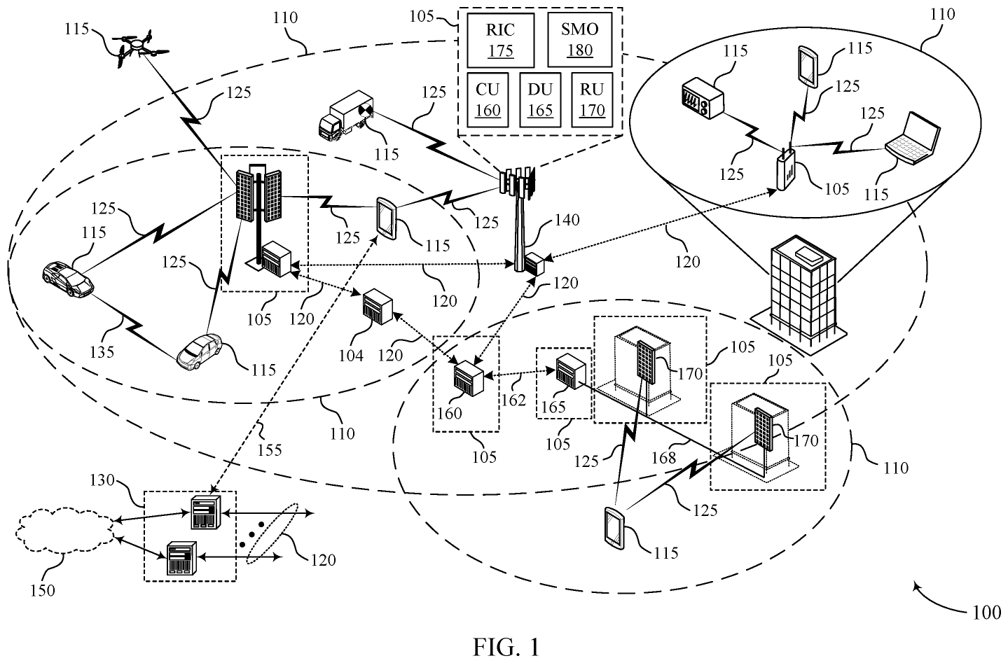

FIG. 1 shows an example of a wireless communications system 100 that supports cooperative HARQ-ACK feedback reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cooperative HARQ-ACK feedback reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, an object may carry a UE 115. In some examples, a user (e.g., human) may carry multiple UEs 115 (e.g., smartphone, smart watch, head-mounted display, notebook computer, among other examples). In some examples, a vehicle (e.g., cars, drones, automated guided vehicles) may carry multiple UEs 115 (e.g., infotainment system, electronic control unit, among other examples).

In some implementations, detecting and monitoring the association relationship between the UE 115 and the object may enhance various applications. In some examples, the object and the UE 115 may be associated. In such examples, the object may be a proxy of the UE 115, or vice versa, for tracking and managing the UE 115. In some examples, the association between the UE 115 and the object may be permanent. In other examples, the association may be temporary. In some implementations, the object may be detectable through different perception schemes. In some examples, the object may retain detectable characteristics. For example, the object may have a large rich communication service (RCS) message, a micro-Doppler profile, or temperature, among other examples.

In some implementations, the UE 115 may be an ordinary device with specific capabilities. For example, the UE 115 may have positioning capability, sensing capability, or both (e.g., NR positioning or sensing). In some implementations, the UE 115 and object association may have various applications. For example, the UE 115 and object association may be used in sensing-assisted beam management, maximum power extrapolation (MPE) detection and mitigation, multi-device aggregation, public security, device anti-theft, health monitoring (e.g., vital sign monitoring or fall detection), among other examples.

In some implementations, an object may be associated with multiple UEs 115. In some examples, a user may carry a smartphone, a smart watch, and smart glasses together. In some examples, multiple users (e.g., carrying UEs 115) may be on the same vehicle (bus, train, or the like). In some examples, the UEs 115 may connect (e.g., Bluetooth, sidelink, among other examples) to each other. In other examples, the UEs 115 may not connect to each other. In some implementations, UEs 115 may be associated with the same object. In such implementations, the UEs 115 may have similar physical characteristics. For example, the UEs 115 may have similar positions and movement patterns. Additionally, or alternatively, the UEs 115 may have similar beams and link qualities.

In some implementations, the UE 115 and object association may be based on multiple device aggregation. In some examples, the network entity 105 may detect the association between an object and multiple UEs 115. In such examples, the network entity 105 may aggregate the UEs 115 to share the same (e.g., physical layer (PHY) or medium access control (MAC)) procedures to save device power, network power, and system overhead. For example, the procedures may be beam management and CSI measurement and reporting, radio resource management (RRM), cell reselection, positioning, among other examples. In some examples, the network entity 105, or one of the aggregate UEs 115, may select a primary UE 115. In some cases, the primary UE 115 may perform the procedures on behalf of the other aggregate UEs 115.

In some implementations, UE group operations may include CSI measurements, position, and mobility for a group of UEs 115 that may have similar properties, conditions, or metrics (e.g., channel measurements or qualities). In such implementations, the UE group operations may reduce network power usage and UE 115 power usage. In some examples, multiple UEs 115 may belong to a same user. In some examples, the UEs 115 in the UE group may have the same properties.

In some implementations, the UEs 115 within the UE group may support shared feedback resources so that a UE 115 may access and utilize any quantity of feedback resources associated with any UE 115 that belongs to the same cooperative group. For example, the network entity 105 may assign a first set of feedback resources to a first UE 115 within a cooperative UE group and the network entity 105 may assign a second set of feedback resources to a second UE 115 within the same cooperative UE group. Then, based on various factors such as latency, feedback priority, and resource availability, the first UE 115 may use the second set of feedback resources (associated with the second UE 115) to transmit HARQ feedback to the network entity 105, for example, in cases where the second set of resources occur prior to the first set of resources, or are associated with a higher signaling reliability. Additionally, or alternatively, the first UE 115 may transmit its own feedback to the second UE 115, and the second UE 115 may relay the feedback for the first UE 115 (e.g., to a network entity 105) using the second set of resources.

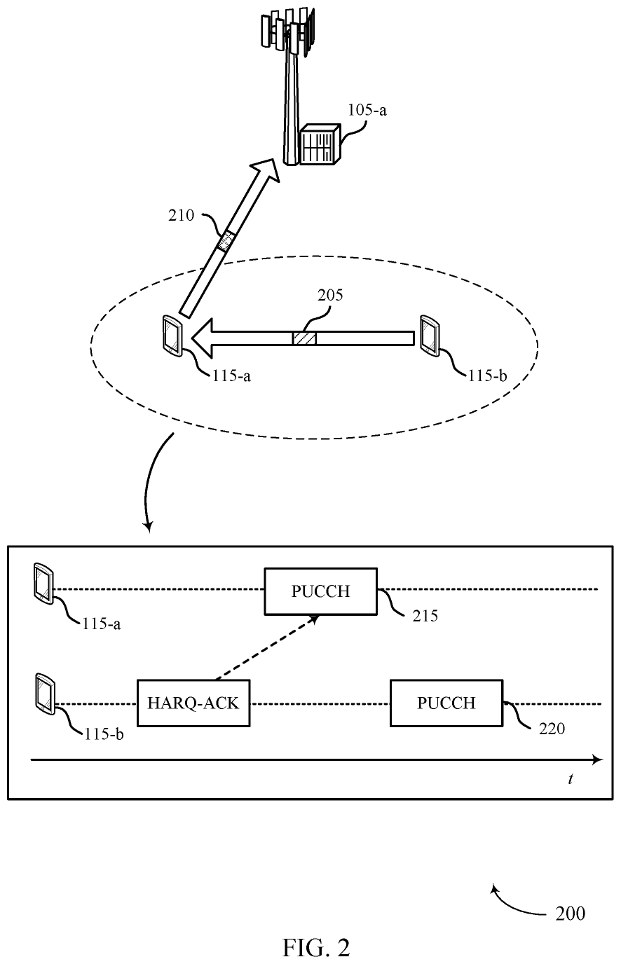

FIG. 2 shows an example of a wireless communications system 200 that supports cooperative HARQ-ACK feedback reporting in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described with reference to FIG. 1.

Wireless communications system 100 may support communications for a quantity of UEs 115 (e.g., a threshold quantity of UEs) within a coverage area, for example, UEs may be located within a geographic area or located within a threshold distance or range from one another. To save device power and signaling overhead, the UEs may be aggregated together or form one or more groups of UEs, where the UEs may share parameters for beam management procedures or channel measurement, among other processes. In some implementations, multiple UEs 115 may be associated with one another (or linked together) based on an association the multiple UEs 115 have with a common object. For example, one UE 115 (e.g., a smart watch) and another UE 115 (e.g., a phone) may have an association with a same user and may be grouped together based on the association with the same user. Additionally, or alternatively, a connected vehicle and a UE 115 (e.g., a smartphone of the driver) may have an association (e.g., the connected vehicle may subscribe to the network for periodic traffic data download) and may be grouped together based on the association.

In some grouped UE 115 deployments, the UEs 115 may report and signal different types of device measurements (such as channel state reporting, positioning and mobility measurements, or the like) per-UE group, for example, when the UEs 115 may have the same or similar properties). In some cases, however, a network entity may assign each UE 115 individual sets of feedback resources (e.g., physical uplink control channel (PUCCH) resources), such that each individual UE 115 may use its assigned set of feedback resources to send HARQ feedback messaging to the network relating to service quality and other aspects of signaling quality. Such individually assigned feedback resources, however, may not be optimized for the group-UE environment.

Accordingly, techniques described herein may support shared feedback resources so that a UE 115 may access and utilize any quantity of feedback resources associated with any UE 115 that may belong to a same UE group. For example, a network entity 105-a may assign a UE 115-a uplink resources 215 within a UE group and the network entity 105-a may assign a UE 115-b uplink resources 220 within the same UE group. Then, based on various factors such as latency, feedback priority, and resource availability, among other factors, the UE 115-b may use the uplink resources 215 (associated with the UE 115-a) to transmit HARQ feedback to the network entity 105-a, for example, in cases where the uplink resources 215 may occur prior to the uplink resources 220. Additionally, or alternatively, the UE 115-b may transmit its own feedback to the UE 115-a, and the UE 115-a may relay the feedback for the UE 115-b on the uplink resources 220. In some implementations, a UE group may include more than two UEs 115 (e.g., a first UE 115 may use any other UE 115 in the UE group to enable lower latency for HARQ-ACK feedback).

In some implementations, a UE 115-a may indicate a capability that the UE 115-a may assist the UE 115-b in transmitting the feedback of UE 115-b (e.g., to reduce latency, improve reliability, or both). In some implementations, the UE 115-a may be capable of supporting the feedback of UE 115-b. In such implementations, the network entity 105-a may configure the UE 115-a with a capability to support sending feedback for other UEs 115 in the UE group. In some examples, the configuration may be a “per-cell configuration” (e.g., the capability is configured on a per-cell basis), a “per-BWP configuration” (e.g., the capability is configured on a per-BWP basis), or both. In some examples, the network entity 105-a may change the behavior of the UE 115-a (e.g., in a dynamic way). For example, enabling UE 115-a support per BWP may allow the UE 115-a to prioritize its own transmission instead of transmissions for other UEs 115 based on the BWP configurations. In some examples, the BWP configurations may include respective PUCCH configurations (e.g., PUCCH-Config) which may indicate a priority for transmissions for the UE 115-a.

In some implementations, the network entity 105-a may configure the UEs 115-a and 115-b to be in the same UE group (e.g., configured from a HARQ-ACK perspective). In some examples, the network entity 105-a may enable or disable cooperative feedback reporting via a control message such as a radio resource control (RRC) message, a medium access control-control element (MAC-CE) message, or downlink control information (DCI) signaling, or any combination thereof. In such examples, the UEs 115 in the group may share feedback reporting (for enabled cooperative feedback) or refrain from sharing feedback reporting (for disabled cooperative feedback).

In some implementations, the UEs 115-a and 115-b may configure the UE group (e.g., nearby UEs 115 may start or configure a UE group). For example, the UEs 115-a and 115-b may be in the same UE group based on relatively close proximity to one another. In some such examples, the UEs 115-a and 115-b may share group information (e.g., UE 115 identities (IDs) or other identifying information, capabilities, or other parameters) with the network entity 105-a to notify the network entity 105-a of the UE group. In some other implementations, the network entity 105-a may assign UE 115-a and UE 115-b the uplink resources 215 and uplink resources 220, respectively, for the UEs 115 to transmit feedback (e.g., HARQ-ACK feedback). In some examples, the uplink resources 215 and 220 may be PUCCH resources. In some implementations, the network entity 105-a may share the uplink resources 215 and 220 of each UE 115 in the group (e.g., UE 115-a and UE 115-b) with the other UEs 115 in the group (e.g., the UEs 115-a and 115-b may be aware of each other's uplink resources by network configuration).

In some implementations, the UEs 115-a and UE 115-b may share the uplink resources 215 and 220 through radio access technology (RAT) techniques (e.g., sidelink), non-RAT techniques (e.g., Bluetooth or ultra-wideband), or both. In some examples, one of the UEs 115 may indicate to the network entity 105-a the sharing of the uplink resources 215 and 220 (e.g., when the sharing occurs). For example, the UE 115-a may transmit the indication of uplink resource sharing to the network entity 105-a in a second message 210. Additionally, or alternatively, each of the UEs 115 in the UE group may indicate the sharing of uplink resources to the network entity 105-a.

In some implementations, the UE 115-b may be aware that UE 115-a is configured with the uplink resources 215. In such cases, the UE 115-b may transmit feedback in a first message 205 (e.g., HARQ-ACK) through UE 115-a (e.g., via the second message 210) to the network entity 105-a. In some examples, the UE 115-a in the UE group may transmit its own feedback in the second message to the network entity 105-a via resources allocated to the UE 115-b. In some implementations, the UE 115-a may transmit feedback in the second message 210 for a physical downlink control channel (PDSCH) received on a first carrier on a second carrier if PUCCH resources exist (e.g., for reduced latency).

In some implementations, the UE 115-a may have two or more HARQ-ACK feedback messages to report to the network entity 105-a (e.g., its own and the feedback of UE 115-b). In some examples, the UE 115-a may indicate the identity of the feedback to the network entity 105-a in the second message 210 (e.g., whether the feedback is for UE 115-a, UE 115-b, or a joint feedback). In some implementations, the UE 115-a may transmit feedback based on the priority of the feedback messages. For example, the UE 115-a may transmit its own feedback when the UE 115-a has a higher priority than UE 115-b. Additionally, or alternatively, UE 115-b may refrain from transmitting the feedback until the next available resource.

In some implementations, the UE 115-a may report feedback messages based on a rule (e.g., irrespective of priority). For example, the network entity 105-a may instruct the UE 115-a to report its own feedback or the UE 115-b feedback. In some examples, one of the UEs 115 in the UE group may configure the UE 115-a to report its own feedback or the UE 115-b feedback. In some implementations, the UE 115-a may report feedback messages based on a joint HARQ-ACK feedback codebook configuration. For example, the UE 115-a may report the joint feedback codeword to the network entity 105-a in the second message 210.

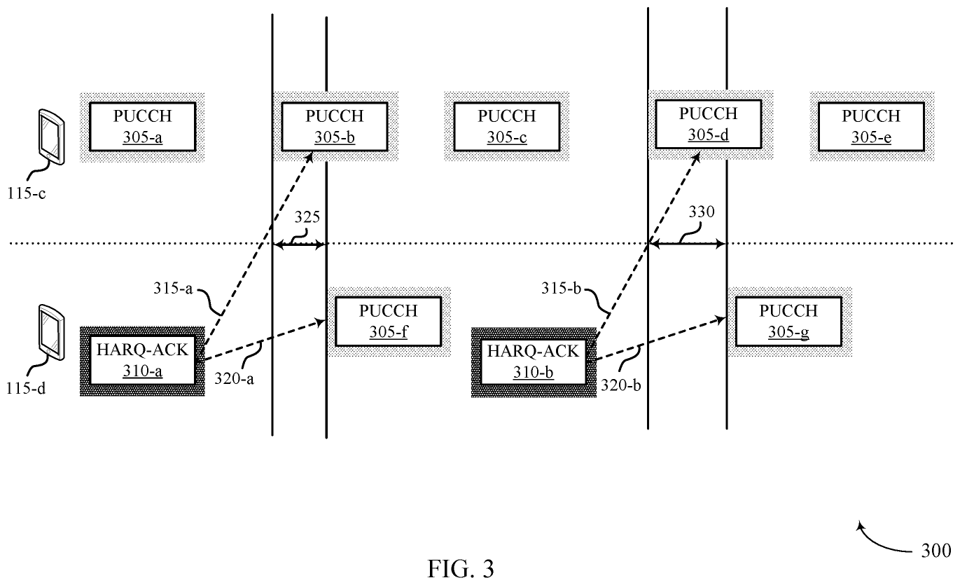

FIG. 3 shows an example of a wireless communications system 300 that supports cooperative HARQ-ACK feedback reporting in accordance with one or more aspects of the present disclosure. In some cases, the wireless communications system 300 may implement or be implemented by aspects of the wireless communications system 100 or 200. For example, the wireless communications system 300 may include one or more UEs 115 (e.g., a UE 115-c and a UE 115-d), which may be examples of the corresponding devices as described with reference to FIGS. 1 and 2.

In some implementations, a network entity 105 may assign each UE 115-c and UE 115-d uplink resources 305 to use for transmitting feedback messages (e.g., HARQ-ACK feedback messages). In some examples, the uplink resources 305 may be PUCCH resources. In some implementations, the network entity may share the uplink resources 305 of each UE 115 (e.g., UE 115-c and UE 115-d) in the group with the other UEs 115 in the group (e.g., the UEs 115-c and 115-d may be aware of each other's uplink resources based on a network configuration).

In some implementations, the UE 115-d may have two or more HARQ-ACK feedback messages 310 to report to the network entity (e.g., its own and the feedback of UE 115-c). In some examples, the network entity may configure the UE 115-d to transmit both feedback messages 310-a and 310-b (e.g., the UE 115-d may enable cooperative or shared UE reporting in addition to individual reporting to enhance reliability). In some examples, one of the UEs 115 in the UE group may configure the UE 115-d to transmit the feedback message 310-a (via uplink channel 315-a or uplink channel 320-a) and feedback message 310-b (via uplink channel 315-b or uplink channel 320-b. For example, UE 115-d may be associated with high priority communications or may be a high priority UE. In some examples, configuring the UE 115-d to enable cooperative UE 115 reporting in addition to its own reporting may enable diversity in decoding the feedback message 310 (e.g., the feedback message may be transmitted via multiple different links to increase transmission diversity and reliability for subsequent decoding).

Additionally, or alternatively, the UE 115-d may select the uplink resources 305 of UE 115-c (e.g., uplink resource 305-a, uplink resource 305-b, uplink resource 305-c, uplink resource 305-d, or uplink resource 305-e) or its own uplink resources 305-f or 305-g to transmit the feedback message 310 (e.g., which may be its own feedback or the feedback of UE 115-c). In some implementations, the selection may be based on one or more conditions. For example, the UE 115-c uplink resource 305-b and the UE 115-d uplink resource 305-f may be within a threshold duration 325 (e.g., “X” units of time, such as slots, milliseconds, symbols, or the like). In such examples, the UE 115-d may use the uplink resource 305-f for feedback between the UE 115-d and UE 115-c (e.g., the uplink resource 305-b is within the threshold “X” duration).

In some examples, a duration 330 between the UE 115-c uplink resources 305-d and the UE 115-d uplink resource 305-g may exceed a threshold. In such examples, the UE 115-d may use the uplink resource 305-d for feedback between the UE 115-d and UE 115-c (e.g., the uplink resource 305-d is the earliest uplink resource between 305-d and 305-f and the duration 330 exceeds the threshold duration 325).

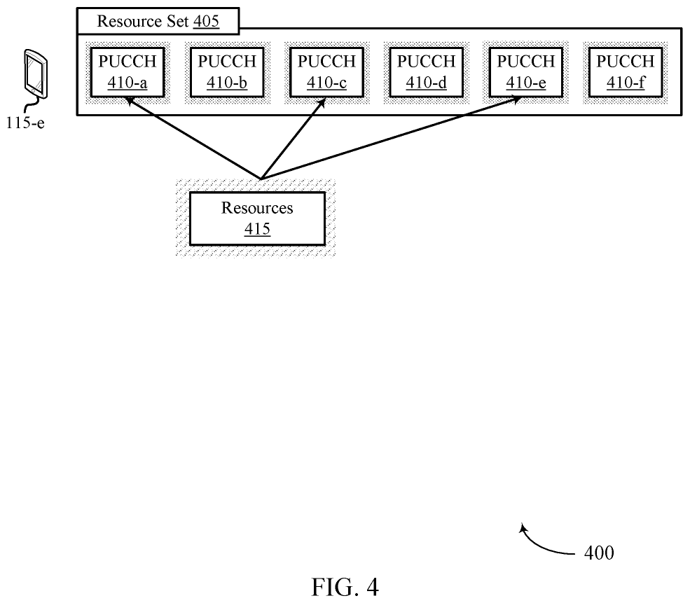

FIG. 4 shows an example of a wireless communications system 400 that supports cooperative HARQ-ACK feedback reporting in accordance with one or more aspects of the present disclosure. In some cases, the wireless communications system 400 may implement or be implemented by aspects of the wireless communications system 100, 200, or 300. For example, the wireless communications system 400 may include one or more UEs 115 (e.g., a UE 115-e), which may be examples of the corresponding devices as described with reference to FIGS. 1, 2, and 3.

In some implementations, a UE 115 (e.g., UE 115-e) may allow one or more uplink resources 410 to be used for cooperative sharing per resource set 405 (e.g., or per resource sets). In some examples, a network entity 105 may indicate the choice of the uplink resources 410 of the resource sets 405. For example, the network entity 105 may select uplink resources 410-a, 410-c, and 410-e for cooperative sharing. In some examples, the network entity 105 may not select uplink resources for cooperative sharing (e.g., uplink resources 410-b, 410-d, and 410-f). In some examples, the UE 115-e may select the uplink resources 410 of resource sets 405. For example, the UE 115-e may select uplink resources 410-a, 410-c, and 410-e for cooperative sharing from the resources 415 used for cooperative feedback.

In some implementations, the UE 115-e may transmit (e.g., via broadcast, multicast, unicast) the uplink resources 410-a, 410-c, and 410-e (e.g., sharable uplink resources) to all UEs 115 of a same UE group. In such implementations, each UE 115 in the UE group may select which uplink resource 410 for a cooperative UE 115 it may use (e.g., for overall latency minimization). In some examples, the UE 115 may share the uplink resources. Additionally, or alternatively, the network entity 105 may share the uplink resources.

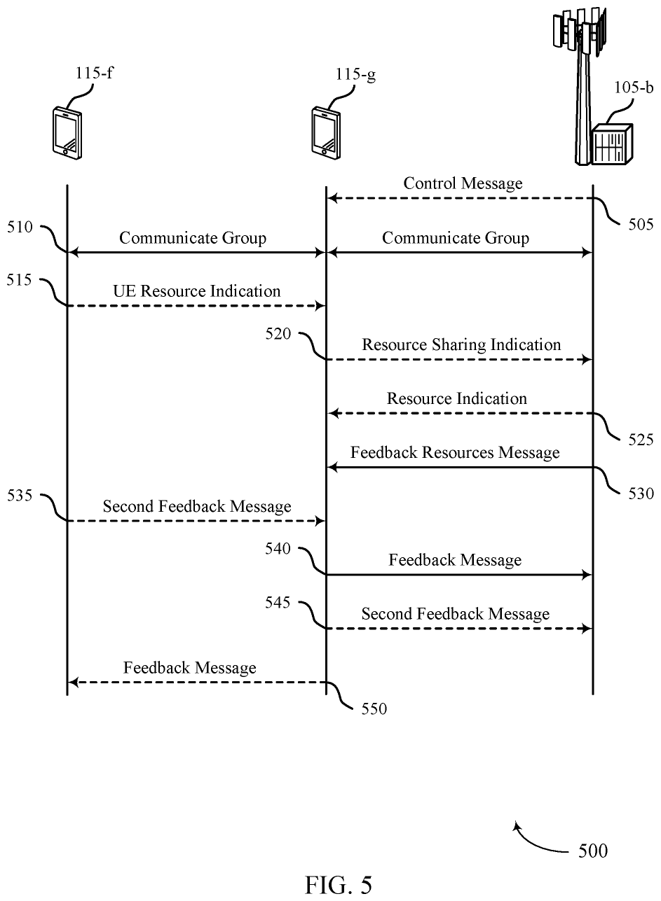

FIG. 5 shows an example of a process flow 500 in a system that supports cooperative HARQ-ACK feedback reporting in accordance with one or more aspects of the present disclosure. In the following description of the process flow 500, the operations between the UE 115-f, UE 115-g, and the network entity 105-b may be transmitted in a different order than the example order shown. Some operations may also be omitted from the process flow 500, and other operations may be added to the process flow 500. Further, although some operations or signaling may be shown to occur at different times for discussion purposes, these operations may occur at the same time.

In some implementations, each UE 115 (e.g., UE 115-g and UE 115-f) of one or more UEs 115 in a UE group may have a capability to share uplink feedback resources to assist uplink feedback reporting based on each UE 115 being in a UE group (e.g., a cooperative UE group). In some implementations, the network entity 105-b may configure the capability in a per cell configuration, per BWP configuration, or both.

At 505, the UE 115-g may receive one or more control messages. In some examples, the one or more control messages may include an activation, or deactivation, of uplink feedback resource sharing for the multiple of UEs 115 (e.g., UE 115-f and UE 115-g) in the UE group. In some implementations, the one or more control messages may include one or more RRC messages, one or more MAC-CE messages, one or more DCI messages, or any combination thereof.

At 510, the UE 115-g may communicate an indication that the UE 115-g is in (e.g., part of, configured for) the UE group. In some examples, the UE group may be associated with uplink feedback resource sharing. In some implementations, the UE group may include multiple UEs including at least the UE 115-g and UE 115-f. In some examples, the UE 115-g may communicate the indication that the UE 115-g is in the UE group to the network entity 105-b. In some examples, the UE 115-g may communicate the indication that the UE 115-g is in the UE group to other UEs 115 in the UE group (e.g., UE 115-f). In some implementations, the UE 115-g may receive one or more UE 115 identifiers from one or more UEs 115 of the multiple of UEs 115 of the UE group. In some examples, the UE 115-g may transmit an indication of one or more UE 115 identifiers associated with the multiple UEs 115 in the UE group to the network entity 105-b.

At 515, the UE 115-g may receive an indication of a second set of uplink feedback resources from the UE 115-f. In some examples, the UE 115-f may configure the second set of uplink feedback resources for the uplink feedback resource sharing for the UEs 115-g and 115-f. In some implementations, the UE 115-g may use the second set of uplink feedback resources from the UE 115-f for cooperative sharing based on the indication. At 520, the UE 115-g may transmit an indication of the uplink feedback resource sharing for the multiple UEs 115 of the UE group to the network entity 105-b. For example, the UE 115-g may transmit an indication of the second set of uplink feedback resources received from the UE 115-f.

At 525, the UE 115-g may receive an indication of one or more resources of the first set of uplink feedback resources or the second set of uplink resources from the network entity 105-b. In some implementations, the network entity 105-b may configure the one or more resources for the uplink feedback resource sharing. For example, the UE 115-g may use the one or more resources for resource sharing based on the indication.

At 530, the UE 115-g may receive one or more messages indicating a first set of uplink feedback resources allocated for the UE 115-g. Additionally, or alternatively, the one or more messages may indicate the second set of uplink feedback resources allocated for the UE 115-f. In some implementations, the network entity 105-b may configure the first set of uplink feedback resources and the second set of uplink feedback resources for the uplink feedback resource sharing for UEs 115 based on the UE 115-g and UE 115-f both being in the UE group. In some implementations, the UE 115-g may receive an indication of multiple sets of feedback resources including respective resources for each of the multiple UEs 115 of the UE group. In some examples, network entity 105-b may configure the multiple sets of feedback resources for the uplink feedback resource sharing.

At 535, the UE 115-g may receive a second feedback message including feedback associated with the UE 115-f. At 540, the UE 115-g may transmit one or more feedback messages associated with the UE group based on a selection of a set of shared resources from the first set of uplink resources, the second set of uplink feedback resources, or both. In some implementations, the UE 115-g may transmit the one or more feedback messages via the second set of uplink feedback resources allocated for the UE 115-f based on the UE 115-g and the UE 115-f both being in the UE group. In some implementations, one or more feedback messages associated with the UE group may include the feedback associated with the UE 115-f.

In some implementations, the UE 115-g may transmit a first feedback message of the one or more feedback messages associated with the UE 115-g via a first feedback resource. In some examples, the UE 115-g may transmit a second feedback message of the one or more feedback messages associated with the UE 115-f via the first feedback resource. In some examples, the UE 115-g may transmit the second feedback message via a second feedback resource based on a priority of the second feedback message. In some implementations, the UE 115-g may transmit the one or more feedback messages as a joint feedback codeword. In some examples, the joint feedback codeword may indicate first feedback associated with the UE 115-g and second feedback associated with the UE 115-f.

In some implementations, the UE 115-g may transmit the one or more feedback messages via the first set of uplink feedback resources based on the first set of uplink feedback resources occurring a threshold duration before the second set of uplink feedback resources. Additionally, or alternatively, the UE 115-g may transmit the one or more feedback messages via the second set of uplink feedback resources based on the second set of uplink feedback resources occurring the threshold duration before the second set of uplink feedback resources.

At 545, the UE 115-g may transmit a second feedback message comprising feedback associated with the UE 115-f. In some implementations, the one or more feedback messages associated with the UE group may include feedback associated with the UE 115-f. At 550, the UE 115-g may transmit the one or more feedback messages to the UE 115-f. In some implementations, the one or more feedback messages may include feedback associated with the UE 115-g.

In some implementations, the UE group may include a third UE (or any additional quantity of UEs 115). For example, the UE 115-g may receive an indication of a third set of uplink feedback resources allocated for a third UE. In some examples, the network entity 105-b may configure the third set of uplink feedback resources for the uplink feedback resource sharing for UEs 115 based on the UE 115-g, the UE 115-f, and the third UE 115 being in the UE group. In some examples, the UE 115-g may transmit the one or more feedback messages via the third set of uplink feedback resources based on the third set of uplink feedback resources occurring before both the first set of uplink feedback resources and the second set of uplink feedback resources.

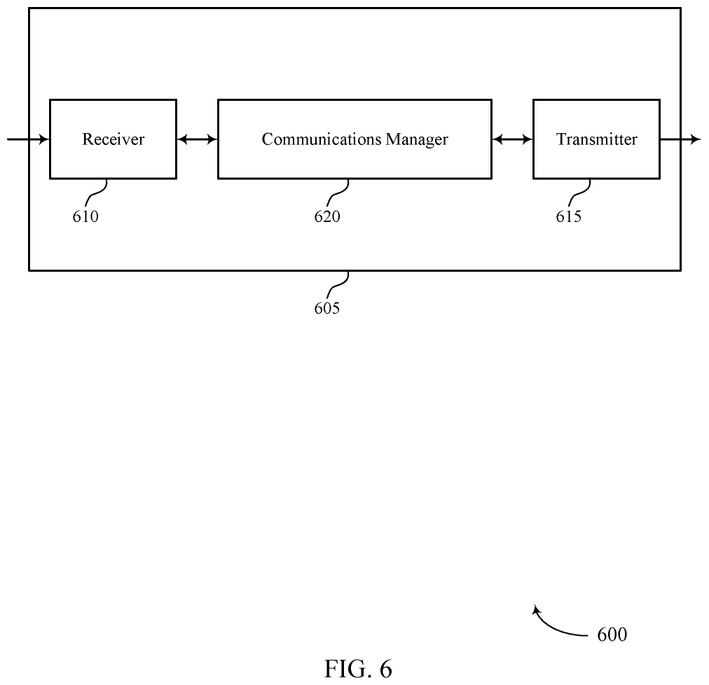

FIG. 6 shows a block diagram 600 of a device 605 that supports cooperative HARQ-ACK feedback reporting in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to cooperative HARQ-ACK feedback reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to cooperative HARQ-ACK feedback reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of cooperative HARQ-ACK feedback reporting as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for communicating an indication that the first UE is in a UE group associated with uplink feedback resource sharing, where the UE group includes a set of multiple UEs including the first UE and a second UE. The communications manager 620 is capable of, configured to, or operable to support a means for receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The communications manager 620 is capable of, configured to, or operable to support a means for transmitting one or more feedback messages associated with the UE group based on a selection of a set of shared resources from the first set of uplink feedback resources or the second set of uplink feedback resources.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other advantages.

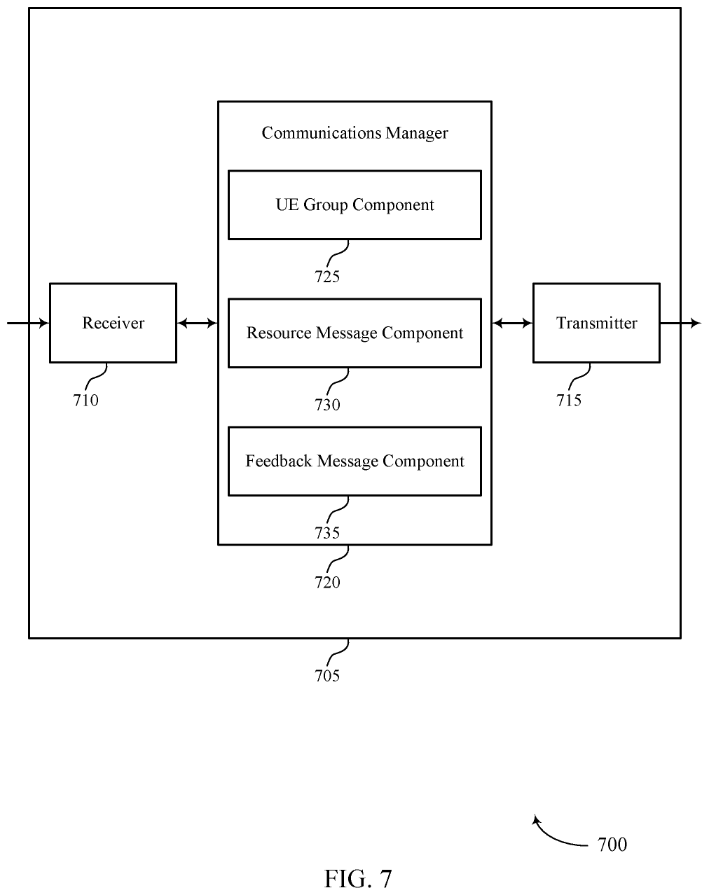

FIG. 7 shows a block diagram 700 of a device 705 that supports cooperative HARQ-ACK feedback reporting in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to cooperative HARQ-ACK feedback reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cooperative HARQ-ACK feedback reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of cooperative HARQ-ACK feedback reporting as described herein. For example, the communications manager 720 may include a UE group component 725, a resource message component 730, a feedback message component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The UE group component 725 is capable of, configured to, or operable to support a means for communicating an indication that the first UE is in a UE group associated with uplink feedback resource sharing, where the UE group includes a set of multiple UEs including the first UE and a second UE. The resource message component 730 is capable of, configured to, or operable to support a means for receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The feedback message component 735 is capable of, configured to, or operable to support a means for transmitting one or more feedback messages associated with the UE group based on a selection of a set of shared resources from the first set of uplink feedback resources or the second set of uplink feedback resources.

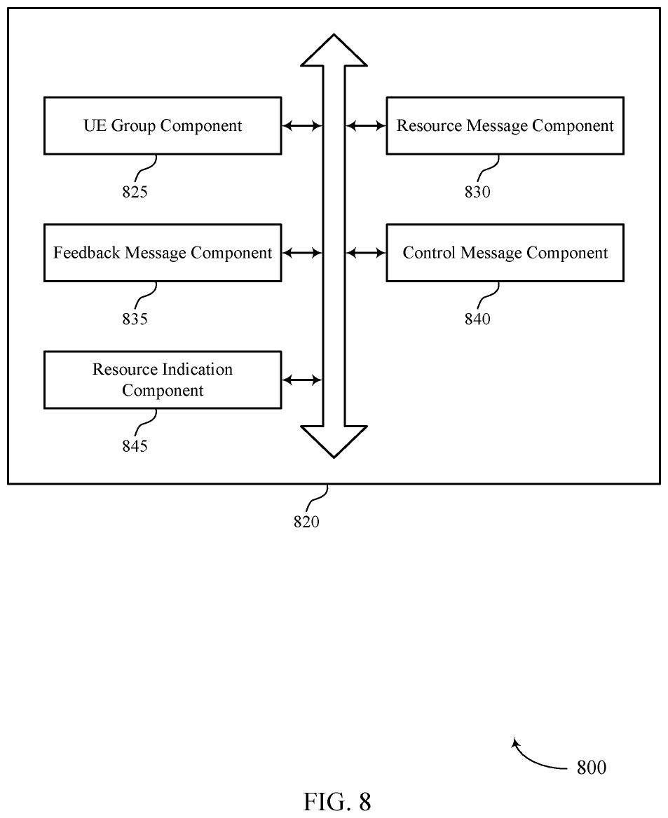

FIG. 8 shows a block diagram 800 of a communications manager 820 that supports cooperative HARQ-ACK feedback reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cooperative HARQ-ACK feedback reporting as described herein. For example, the communications manager 820 may include a UE group component 825, a resource message component 830, a feedback message component 835, a control message component 840, a resource indication component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The UE group component 825 is capable of, configured to, or operable to support a means for communicating an indication that the first UE is in a UE group associated with uplink feedback resource sharing, where the UE group includes a set of multiple UEs including the first UE and a second UE. The resource message component 830 is capable of, configured to, or operable to support a means for receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The feedback message component 835 is capable of, configured to, or operable to support a means for transmitting one or more feedback messages associated with the UE group based on a selection of a set of shared resources from the first set of uplink feedback resources or the second set of uplink feedback resources.

In some examples, to support transmitting the one or more feedback messages, the feedback message component 835 is capable of, configured to, or operable to support a means for transmitting the one or more feedback messages via the second set of uplink feedback resources allocated for the second UE based on the first UE and the second UE both being in the UE group.

In some examples, the feedback message component 835 is capable of, configured to, or operable to support a means for receiving, from the second UE, a second feedback message including feedback associated with the second UE, where the one or more feedback messages associated with the cooperative group UE include the feedback associated with the second UE.

In some examples, to support transmitting the one or more feedback messages, the feedback message component 835 is capable of, configured to, or operable to support a means for transmitting the one or more feedback messages to the second UE, where the one or more feedback messages include feedback associated with the first UE.

In some examples, to support receiving the one or more messages, the resource message component 830 is capable of, configured to, or operable to support a means for receiving an indication of a set of multiple sets of feedback resources including respective resources for each of the set of multiple UEs of the UE group, where the set of multiple sets of feedback resources are configured for the uplink feedback resource sharing.

In some examples, the resource message component 830 is capable of, configured to, or operable to support a means for receiving, from the second UE, an indication of the second set of uplink feedback resources that are configured for the uplink feedback resource sharing for the first UE and the second UE. In some examples, the resource message component 830 is capable of, configured to, or operable to support a means for transmitting, to a network entity, an indication of the uplink feedback resource sharing for the set of multiple UEs of the UE group.

In some examples, to support communicating the indication that the first UE is in the UE group, the UE group component 825 is capable of, configured to, or operable to support a means for receiving, from one or more UEs of the set of multiple UEs of the UE group, one or more UE identifiers. In some examples, to support communicating the indication that the first UE is in the UE group, the UE group component 825 is capable of, configured to, or operable to support a means for transmitting, to a network entity, an indication of one or more UE identifiers associated with the set of multiple UEs in the UE group.

In some examples, the control message component 840 is capable of, configured to, or operable to support a means for receiving, via one or more control messages, an indication of activation or deactivation of the uplink feedback resource sharing for the set of multiple UEs in the UE group, where the one or more control messages include one or more radio resource control messages, one or more medium access control-control elements, one or more downlink control information messages, or any combination thereof.

In some examples, to support transmitting the one or more feedback messages, the feedback message component 835 is capable of, configured to, or operable to support a means for transmitting a first feedback message of the one or more feedback messages associated with the first UE via a first feedback resource. In some examples, to support transmitting the one or more feedback messages, the feedback message component 835 is capable of, configured to, or operable to support a means for transmitting a second feedback message of the one or more feedback messages associated with the second UE via the first feedback resource or via a second feedback resource based on a priority of the second feedback message.

In some examples, to support transmitting the one or more feedback messages, the feedback message component 835 is capable of, configured to, or operable to support a means for transmitting the one or more feedback messages as a joint feedback codeword that indicates first feedback associated with the first UE and second feedback associated with the second UE.

In some examples, to support transmitting the one or more feedback messages, the feedback message component 835 is capable of, configured to, or operable to support a means for transmitting the one or more feedback messages via the first set of uplink feedback resources based on the first set of uplink feedback resources occurring a threshold duration of time before the second set of uplink feedback resources or via the second set of uplink feedback resources based on the second set of uplink feedback resources occurring the threshold duration of time before the second set of uplink feedback resources.

In some examples, each UE of the set of multiple UEs has a capability to share uplink feedback resources to assist uplink feedback reporting based on each UE being in the UE group. In some examples, the capability is configured per cell configuration, per bandwidth part configuration, or both.

In some examples, the resource indication component 845 is capable of, configured to, or operable to support a means for receiving an indication of a third set of uplink feedback resources allocated for a third UE, where the third set of uplink feedback resources is configured for the uplink feedback resource sharing for UEs based on the first UE, the second UE, and the third UE being in the UE group, where the one or more feedback messages are transmitted via the third set of uplink feedback resources based on the third set of uplink feedback resources occurring before both the first set of uplink feedback resources and the second set of uplink feedback resources.

In some examples, the resource indication component 845 is capable of, configured to, or operable to support a means for receiving an indication of one or more resources of the first set of uplink feedback resources or the second set of uplink feedback resources, the one or more resources configured for the uplink feedback resource sharing.

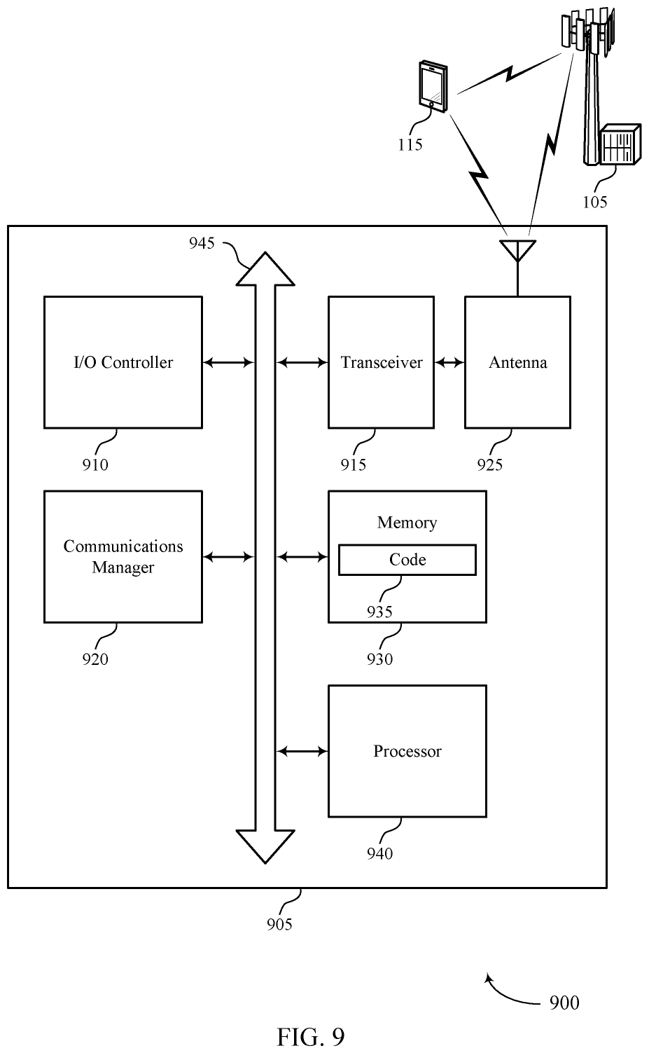

FIG. 9 shows a diagram of a system 900 including a device 905 that supports cooperative HARQ-ACK feedback reporting in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting cooperative HARQ-ACK feedback reporting). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for communicating an indication that the first UE is in a UE group associated with uplink feedback resource sharing, where the UE group includes a set of multiple UEs including the first UE and a second UE. The communications manager 920 is capable of, configured to, or operable to support a means for receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The communications manager 920 is capable of, configured to, or operable to support a means for transmitting one or more feedback messages associated with the UE group based on a selection of a set of shared resources from the first set of uplink feedback resources or the second set of uplink feedback resources.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of cooperative HARQ-ACK feedback reporting as described herein, or the at least one processor 940 and the at least one memory 930 may be otherwise configured to, individually or collectively, perform or support such operations.

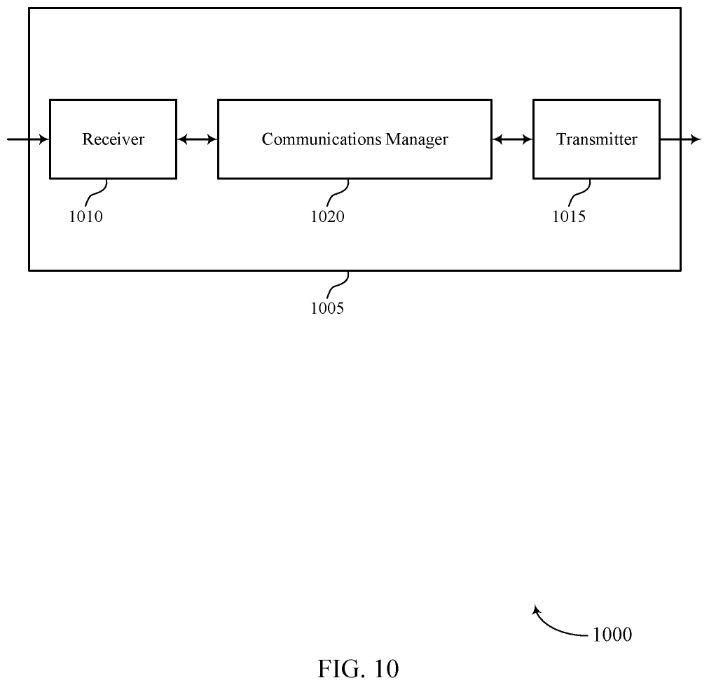

FIG. 10 shows a block diagram 1000 of a device 1005 that supports cooperative HARQ-ACK feedback reporting in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of cooperative HARQ-ACK feedback reporting as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for communicating an indication that a first UE is associated with a UE group associated with uplink feedback resource sharing, the UE group a set of multiple UEs including the first UE and a second UE. The communications manager 1020 is capable of, configured to, or operable to support a means for transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The communications manager 1020 is capable of, configured to, or operable to support a means for receiving one or more feedback messages associated with the UE group based on the uplink feedback resource sharing.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources, among other advantages.

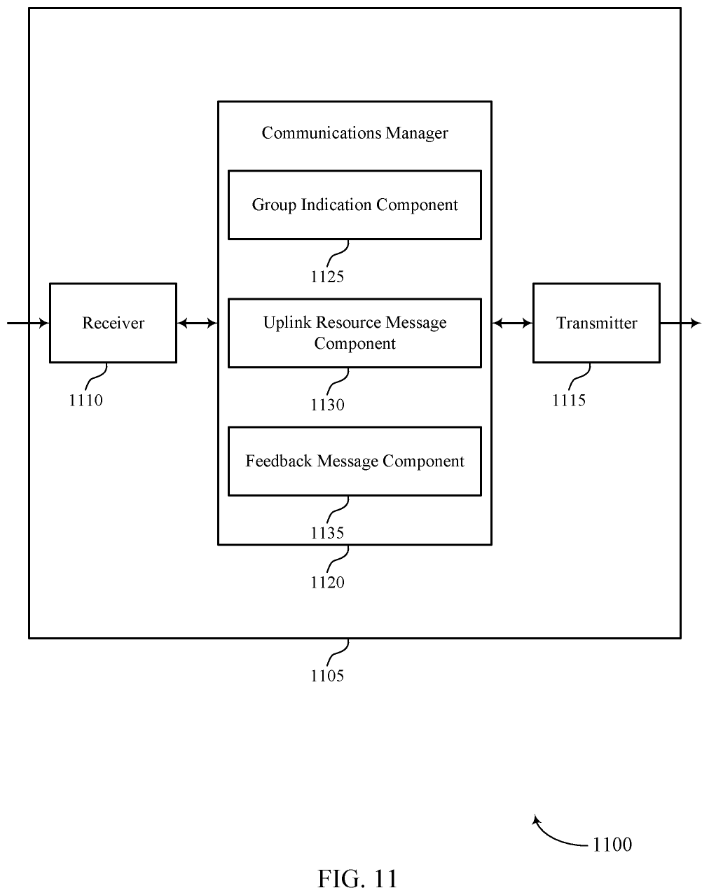

FIG. 11 shows a block diagram 1100 of a device 1105 that supports cooperative HARQ-ACK feedback reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of cooperative HARQ-ACK feedback reporting as described herein. For example, the communications manager 1120 may include a group indication component 1125, an uplink resource message component 1130, a feedback message component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The group indication component 1125 is capable of, configured to, or operable to support a means for communicating an indication that a first UE is associated with a UE group associated with uplink feedback resource sharing, the UE group a set of multiple UEs including the first UE and a second UE. The uplink resource message component 1130 is capable of, configured to, or operable to support a means for transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The feedback message component 1135 is capable of, configured to, or operable to support a means for receiving one or more feedback messages associated with the UE group based on the uplink feedback resource sharing.

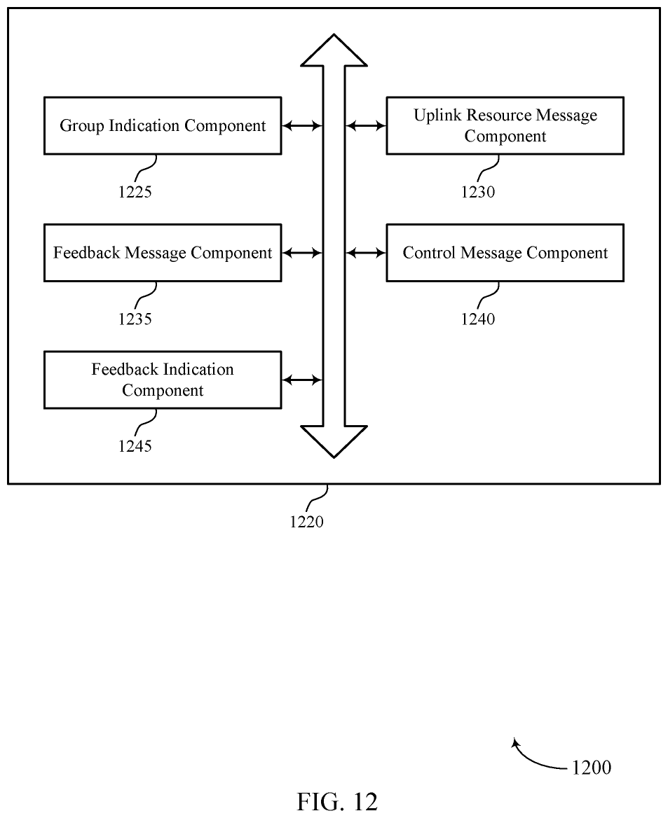

FIG. 12 shows a block diagram 1200 of a communications manager 1220 that supports cooperative HARQ-ACK feedback reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cooperative HARQ-ACK feedback reporting as described herein. For example, the communications manager 1220 may include a group indication component 1225, an uplink resource message component 1230, a feedback message component 1235, a control message component 1240, a feedback indication component 1245, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The group indication component 1225 is capable of, configured to, or operable to support a means for communicating an indication that a first UE is associated with a UE group associated with uplink feedback resource sharing, the UE group a set of multiple UEs including the first UE and a second UE. The uplink resource message component 1230 is capable of, configured to, or operable to support a means for transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The feedback message component 1235 is capable of, configured to, or operable to support a means for receiving one or more feedback messages associated with the UE group based on the uplink feedback resource sharing.

In some examples, the feedback message component 1235 is capable of, configured to, or operable to support a means for receiving, from the first UE, a second feedback message including feedback associated with the second UE, where the one or more feedback messages associated with the UE group include the feedback associated with the second UE.

In some examples, to support receiving the one or more feedback messages, the feedback message component 1235 is capable of, configured to, or operable to support a means for receiving, from the first UE and via the first set of uplink feedback resources allocated for the first UE, the one or more feedback messages associated with the second UE.

In some examples, to support transmitting the one or more messages, the uplink resource message component 1230 is capable of, configured to, or operable to support a means for transmitting an indication of a set of multiple sets of feedback resources including respective resources for each of the set of multiple UEs of the UE group, where the set of multiple sets of feedback resources are configured for the uplink feedback resource sharing.

In some examples, the uplink resource message component 1230 is capable of, configured to, or operable to support a means for receiving an indication of the uplink feedback resource sharing for the set of multiple UEs of the UE group.

In some examples, to support communicating the indication that the first UE is in the UE group, the group indication component 1225 is capable of, configured to, or operable to support a means for receiving one or more UE identifiers associated with the set of multiple UEs in the UE group.

In some examples, the control message component 1240 is capable of, configured to, or operable to support a means for transmitting, via one or more control messages, an indication of activation or deactivation of the uplink feedback resource sharing for the set of multiple UEs in the UE group, where the one or more control messages include one or more radio resource control messages, one or more medium access control-control elements, one or more downlink control information messages, or any combination thereof.

In some examples, to support receiving the one or more feedback messages, the feedback message component 1235 is capable of, configured to, or operable to support a means for receiving a first feedback message of the one or more feedback messages associated with the first UE via a first feedback resource. In some examples, to support receiving the one or more feedback messages, the feedback message component 1235 is capable of, configured to, or operable to support a means for receiving a second feedback message of the one or more feedback messages associated with the second UE via the first feedback resource or via a second feedback resource based on a priority of the second feedback message.

In some examples, to support receiving the one or more feedback messages, the feedback message component 1235 is capable of, configured to, or operable to support a means for receiving the one or more feedback messages as a joint feedback codeword that indicates first feedback associated with the first UE and second feedback associated with the second UE.

In some examples, to support receiving the one or more feedback messages, the feedback message component 1235 is capable of, configured to, or operable to support a means for receiving the one or more feedback messages based on each UE of the set of multiple UEs having a capability to share uplink feedback resources to assist uplink feedback reporting based on being part of the UE group. In some examples, the capability is configured per cell configuration, per bandwidth part configuration, or both.

In some examples, the feedback indication component 1245 is capable of, configured to, or operable to support a means for transmitting an indication of a third set of uplink feedback resources allocated for a third UE, where the third set of uplink feedback resources is configured for the uplink feedback resource sharing for UEs based on the first UE, the second UE, and the third UE being in the UE group. In some examples, the feedback indication component 1245 is capable of, configured to, or operable to support a means for the one or more feedback messages are transmitted via the third set of uplink feedback resources based on the third set of uplink feedback resources occurring before both the first set of uplink feedback resources and the second set of uplink feedback resources.

In some examples, the feedback indication component 1245 is capable of, configured to, or operable to support a means for transmitting an indication of one or more resources of the first set of uplink feedback resources or the second set of uplink feedback resources, the one or more resources configured for the uplink feedback resource sharing.

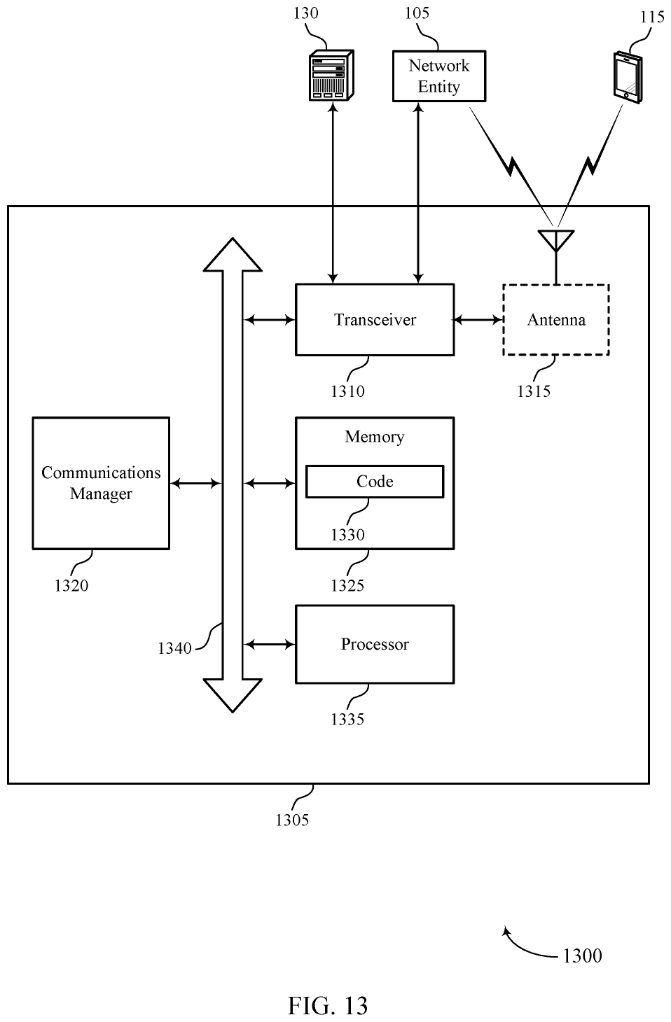

FIG. 13 shows a diagram of a system 1300 including a device 1305 that supports cooperative HARQ-ACK feedback reporting in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting cooperative HARQ-ACK feedback reporting). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105 and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for communicating an indication that a first UE is associated with a UE group associated with uplink feedback resource sharing, the UE group a set of multiple UEs including the first UE and a second UE. The communications manager 1320 is capable of, configured to, or operable to support a means for transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The communications manager 1320 is capable of, configured to, or operable to support a means for receiving one or more feedback messages associated with the UE group based on the uplink feedback resource sharing.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of cooperative HARQ-ACK feedback reporting as described herein, or the at least one processor 1335 and the at least one memory 1325 may be otherwise configured to, individually or collectively, perform or support such operations.

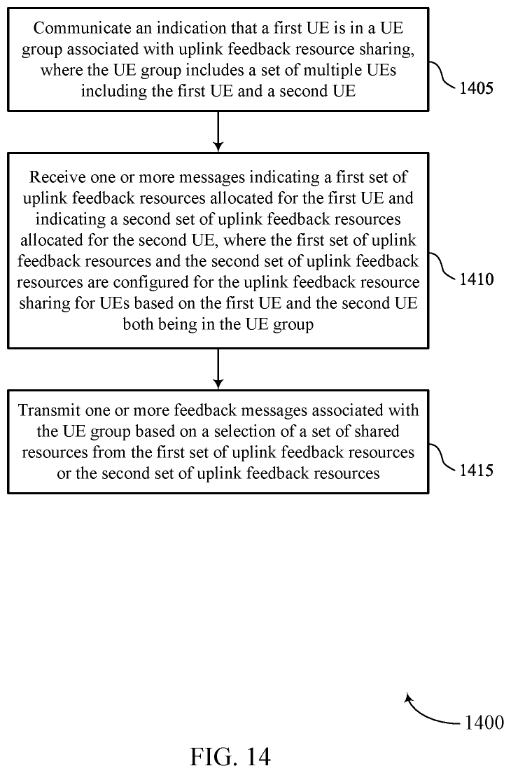

FIG. 14 shows a flowchart illustrating a method 1400 that supports cooperative HARQ-ACK feedback reporting in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include communicating an indication that the first UE is in a UE group associated with uplink feedback resource sharing, where the UE group includes a set of multiple UEs including the first UE and a second UE. The operations of block 1405 may be performed in accordance with examples as disclosed herein. In some examples, aspects of the operations of 1405 may be performed by a UE group component 825 as described with reference to FIG. 8.

At 1410, the method may include receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The operations of block 1410 may be performed in accordance with examples as disclosed herein. In some examples, aspects of the operations of 1410 may be performed by a resource message component 830 as described with reference to FIG. 8.

At 1415, the method may include transmitting one or more feedback messages associated with the UE group based on a selection of a set of shared resources from the first set of uplink feedback resources or the second set of uplink feedback resources. The operations of block 1415 may be performed in accordance with examples as disclosed herein. In some examples, aspects of the operations of 1415 may be performed by a feedback message component 835 as described with reference to FIG. 8.

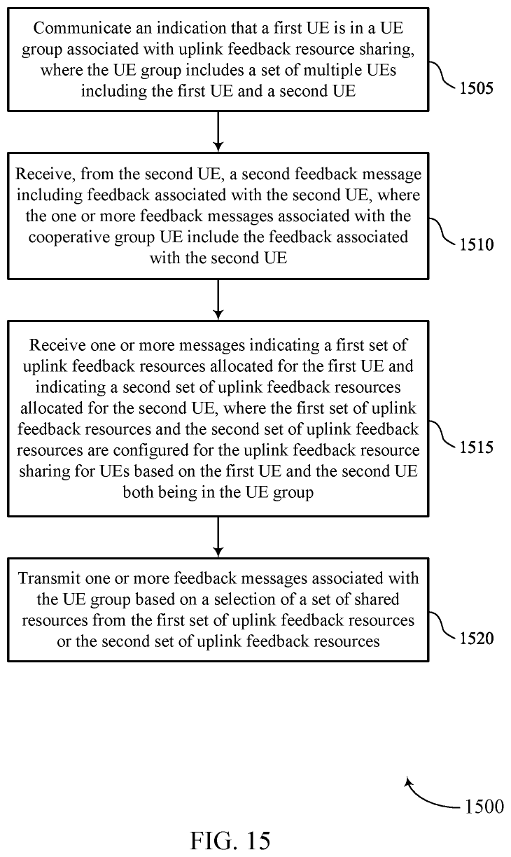

FIG. 15 shows a flowchart illustrating a method 1500 that supports cooperative HARQ-ACK feedback reporting in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include communicating an indication that the first UE is in a UE group associated with uplink feedback resource sharing, where the UE group includes a set of multiple UEs including the first UE and a second UE. The operations of block 1505 may be performed in accordance with examples as disclosed herein. In some examples, aspects of the operations of 1505 may be performed by a UE group component 825 as described with reference to FIG. 8.

At 1510, the method may include receiving, from the second UE, a second feedback message including feedback associated with the second UE, where the one or more feedback messages associated with the cooperative group UE include the feedback associated with the second UE. The operations of block 1510 may be performed in accordance with examples as disclosed herein. In some examples, aspects of the operations of 1510 may be performed by a feedback message component 835 as described with reference to FIG. 8.

At 1515, the method may include receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The operations of block 1515 may be performed in accordance with examples as disclosed herein. In some examples, aspects of the operations of 1515 may be performed by a resource message component 830 as described with reference to FIG. 8.

At 1520, the method may include transmitting one or more feedback messages associated with the UE group based on a selection of a set of shared resources from the first set of uplink feedback resources or the second set of uplink feedback resources. The operations of block 1520 may be performed in accordance with examples as disclosed herein. In some examples, aspects of the operations of 1520 may be performed by a feedback message component 835 as described with reference to FIG. 8.

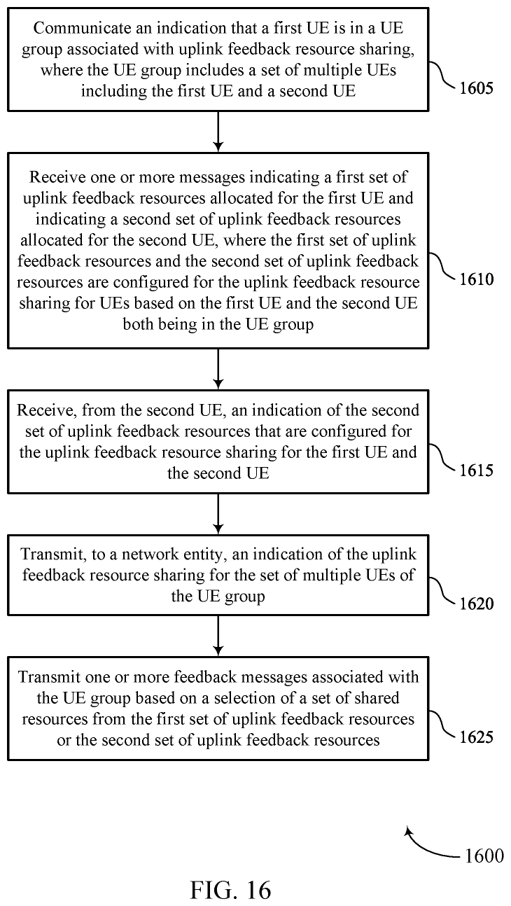

FIG. 16 shows a flowchart illustrating a method 1600 that supports cooperative HARQ-ACK feedback reporting in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include communicating an indication that the first UE is in a UE group associated with uplink feedback resource sharing, where the UE group includes a set of multiple UEs including the first UE and a second UE. The operations of block 1605 may be performed in accordance with examples as disclosed herein. In some examples, aspects of the operations of 1605 may be performed by a UE group component 825 as described with reference to FIG. 8.

At 1610, the method may include receiving one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE both being in the UE group. The operations of block 1610 may be performed in accordance with examples as disclosed herein. In some examples, aspects of the operations of 1610 may be performed by a resource message component 830 as described with reference to FIG. 8.

At 1615, the method may include receiving, from the second UE, an indication of the second set of uplink feedback resources that are configured for the uplink feedback resource sharing for the first UE and the second UE. The operations of block 1615 may be performed in accordance with examples as disclosed herein. In some examples, aspects of the operations of 1615 may be performed by a resource message component 830 as described with reference to FIG. 8.

At 1620, the method may include transmitting, to a network entity, an indication of the uplink feedback resource sharing for the set of multiple UEs of the UE group. The operations of block 1620 may be performed in accordance with examples as disclosed herein. In some examples, aspects of the operations of 1620 may be performed by a resource message component 830 as described with reference to FIG. 8.

At 1625, the method may include transmitting one or more feedback messages associated with the UE group based on a selection of a set of shared resources from the first set of uplink feedback resources or the second set of uplink feedback resources. The operations of block 1625 may be performed in accordance with examples as disclosed herein. In some examples, aspects of the operations of 1625 may be performed by a feedback message component 835 as described with reference to FIG. 8.

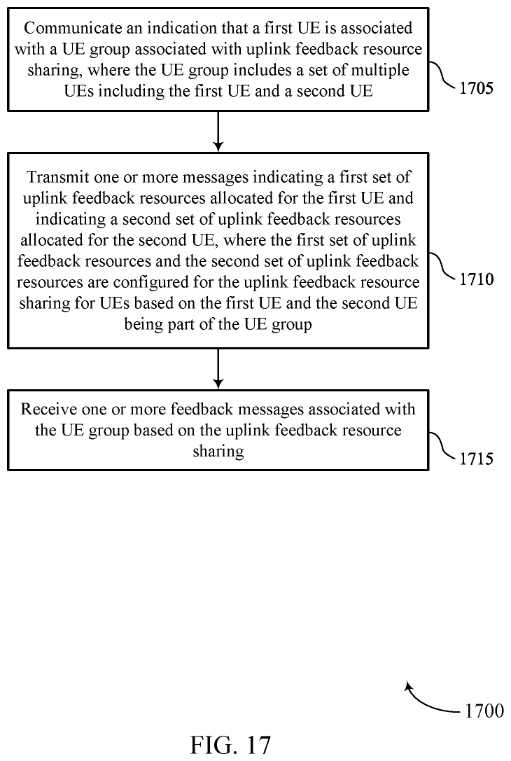

FIG. 17 shows a flowchart illustrating a method 1700 that supports cooperative HARQ-ACK feedback reporting in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include communicating an indication that a first UE is associated with a UE group associated with uplink feedback resource sharing, the UE group a set of multiple UEs including the first UE and a second UE. The operations of block 1705 may be performed in accordance with examples as disclosed herein. In some examples, aspects of the operations of 1705 may be performed by a group indication component 1225 as described with reference to FIG. 12.

At 1710, the method may include transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The operations of block 1710 may be performed in accordance with examples as disclosed herein. In some examples, aspects of the operations of 1710 may be performed by an uplink resource message component 1230 as described with reference to FIG. 12.

At 1715, the method may include receiving one or more feedback messages associated with the UE group based on the uplink feedback resource sharing. The operations of block 1715 may be performed in accordance with examples as disclosed herein. In some examples, aspects of the operations of 1715 may be performed by a feedback message component 1235 as described with reference to FIG. 12.

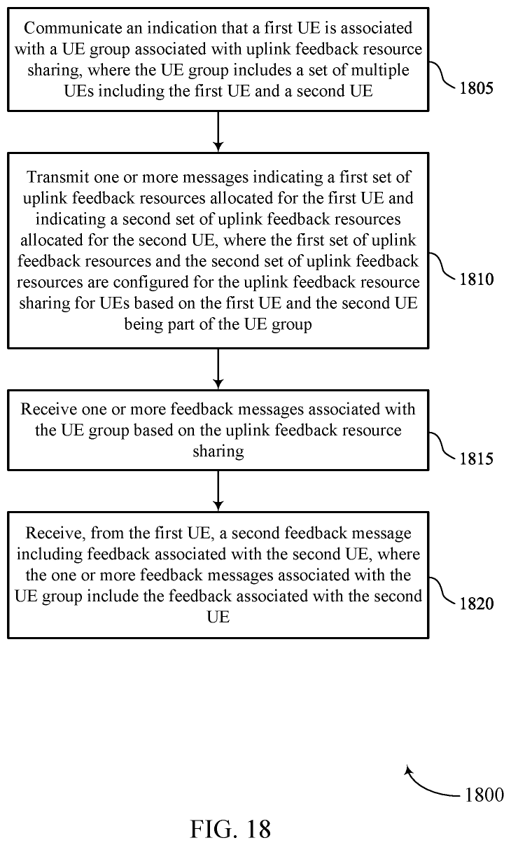

FIG. 18 shows a flowchart illustrating a method 1800 that supports cooperative HARQ-ACK feedback reporting in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include communicating an indication that a first UE is associated with a UE group associated with uplink feedback resource sharing, the UE group a set of multiple UEs including the first UE and a second UE. The operations of block 1805 may be performed in accordance with examples as disclosed herein. In some examples, aspects of the operations of 1805 may be performed by a group indication component 1225 as described with reference to FIG. 12.

At 1810, the method may include transmitting one or more messages indicating a first set of uplink feedback resources allocated for the first UE and indicating a second set of uplink feedback resources allocated for the second UE, where the first set of uplink feedback resources and the second set of uplink feedback resources are configured for the uplink feedback resource sharing for UEs based on the first UE and the second UE being part of the UE group. The operations of block 1810 may be performed in accordance with examples as disclosed herein. In some examples, aspects of the operations of 1810 may be performed by an uplink resource message component 1230 as described with reference to FIG. 12.

At 1815, the method may include receiving one or more feedback messages associated with the UE group based on the uplink feedback resource sharing. The operations of block 1815 may be performed in accordance with examples as disclosed herein. In some examples, aspects of the operations of 1815 may be performed by a feedback message component 1235 as described with reference to FIG. 12.

At 1820, the method may include receiving, from the first UE, a second feedback message including feedback associated with the second UE, where the one or more feedback messages associated with the UE group include the feedback associated with the second UE. The operations of block 1820 may be performed in accordance with examples as disclosed herein. In some examples, aspects of the operations of 1820 may be performed by a feedback message component 1235 as described with reference to FIG. 12.

The following provides an overview of aspects of the present disclosure:

Aspect 1: A method for wireless communications at a first UE, comprising: communicating an indication that the first UE is in a UE group associated with uplink feedback resource sharing, the UE group comprising a plurality of UEs including the first UE and a second UE; receiving one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE both being in the UE group; and transmitting one or more feedback messages associated with the UE group based at least in part on a selection of a set of shared resources from the first set of uplink feedback resources or the second set of uplink feedback resources.

Aspect 2: The method of aspect 1, wherein transmitting the one or more feedback messages comprises: transmitting the one or more feedback messages via the second set of uplink feedback resources allocated for the second UE based at least in part on the first UE and the second UE both being in the UE group.

Aspect 3: The method of any of aspects 1 through 2, further comprising: receiving, from the second UE, a second feedback message comprising feedback associated with the second UE, wherein the one or more feedback messages associated with the cooperative group UE comprise the feedback associated with the second UE.

Aspect 4: The method of any of aspects 1 through 3, wherein transmitting the one or more feedback messages comprises: transmitting the one or more feedback messages to the second UE, wherein the one or more feedback messages comprise feedback associated with the first UE.

Aspect 5: The method of any of aspects 1 through 4, wherein receiving the one or more messages comprises: receiving an indication of a plurality of sets of feedback resources comprising respective resources for each of the plurality of UEs of the UE group, wherein the plurality of sets of feedback resources are configured for the uplink feedback resource sharing.

Aspect 6: The method of any of aspects 1 through 5, further comprising: receiving, from the second UE, an indication of the second set of uplink feedback resources that are configured for the uplink feedback resource sharing for the first UE and the second UE; and transmitting, to a network entity, an indication of the uplink feedback resource sharing for the plurality of UEs of the UE group.

Aspect 7: The method of any of aspects 1 through 6, wherein communicating the indication that the first UE is in the UE group comprises: receiving, from one or more UEs of the plurality of UEs of the UE group, one or more UE identifiers; and transmitting, to a network entity, an indication of one or more UE identifiers associated with the plurality of UEs in the UE group.

Aspect 8: The method of any of aspects 1 through 7, further comprising: receiving, via one or more control messages, an indication of activation or deactivation of the uplink feedback resource sharing for the plurality of UEs in the UE group, wherein the one or more control messages comprise one or more RRC messages, one or more MAC-CEs, one or more DCI messages, or any combination thereof.

Aspect 9: The method of any of aspects 1 through 8, wherein transmitting the one or more feedback messages comprises: transmitting a first feedback message of the one or more feedback messages associated with the first UE via a first feedback resource; and transmitting a second feedback message of the one or more feedback messages associated with the second UE via the first feedback resource or via a second feedback resource based at least in part on a priority of the second feedback message.

Aspect 10: The method of any of aspects 1 through 9, wherein transmitting the one or more feedback messages comprises: transmitting the one or more feedback messages as a joint feedback codeword that indicates first feedback associated with the first UE and second feedback associated with the second UE.

Aspect 11: The method of any of aspects 1 through 10, wherein transmitting the one or more feedback messages comprises: transmitting the one or more feedback messages via the first set of uplink feedback resources based at least in part on the first set of uplink feedback resources occurring a threshold duration of time before the second set of uplink feedback resources or via the second set of uplink feedback resources based at least in part on the second set of uplink feedback resources occurring the threshold duration of time before the second set of uplink feedback resources.

Aspect 12: The method of any of aspects 1 through 11, wherein each UE of the plurality of UEs has a capability to share uplink feedback resources to assist uplink feedback reporting based at least in part on each UE being in the UE group.

Aspect 13: The method of aspect 12, wherein the capability is configured per cell configuration, per bandwidth part configuration, or both.

Aspect 14: The method of any of aspects 1 through 13, further comprising: receiving an indication of a third set of uplink feedback resources allocated for a third UE, wherein the third set of uplink feedback resources is configured for the uplink feedback resource sharing for UEs based at least in part on the first UE, the second UE, and the third UE being in the UE group, wherein the one or more feedback messages are transmitted via the third set of uplink feedback resources based at least in part on the third set of uplink feedback resources occurring before both the first set of uplink feedback resources and the second set of uplink feedback resources.

Aspect 15: The method of any of aspects 1 through 14, further comprising: receiving an indication of one or more resources of the first set of uplink feedback resources or the second set of uplink feedback resources, the one or more resources configured for the uplink feedback resource sharing.

Aspect 16: A method for wireless communications at a network entity, comprising: communicating an indication that a first UE is associated with a UE group associated with uplink feedback resource sharing, the UE group comprising a plurality of UEs including the first UE and a second UE; transmitting one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE being part of the UE group; and receiving one or more feedback messages associated with the UE group based at least in part on the uplink feedback resource sharing.

Aspect 17: The method of aspect 16, further comprising: receiving, from the first UE, a second feedback message comprising feedback associated with the second UE, wherein the one or more feedback messages associated with the UE group comprise the feedback associated with the second UE.

Aspect 18: The method of any of aspects 16 through 17, wherein receiving the one or more feedback messages comprises: receiving, from the first UE and via the first set of uplink feedback resources allocated for the first UE, the one or more feedback messages associated with the second UE.

Aspect 19: The method of any of aspects 16 through 18, wherein transmitting the one or more messages comprises: transmitting an indication of a plurality of sets of feedback resources comprising respective resources for each of the plurality of UEs of the UE group, wherein the plurality of sets of feedback resources are configured for the uplink feedback resource sharing.

Aspect 20: The method of any of aspects 16 through 19, further comprising: receiving an indication of the uplink feedback resource sharing for the plurality of UEs of the UE group.

Aspect 21: The method of any of aspects 16 through 20, wherein communicating the indication that the first UE is in the UE group comprises: receiving one or more UE identifiers associated with the plurality of UEs in the UE group.

Aspect 22: The method of any of aspects 16 through 21, further comprising: transmitting, via one or more control messages, an indication of activation or deactivation of the uplink feedback resource sharing for the plurality of UEs in the UE group, wherein the one or more control messages comprise one or more RRC messages, one or more MAC-CEs, one or more DCI messages, or any combination thereof.

Aspect 23: The method of any of aspects 16 through 22, wherein receiving the one or more feedback messages comprises: receiving a first feedback message of the one or more feedback messages associated with the first UE via a first feedback resource; and receiving a second feedback message of the one or more feedback messages associated with the second UE via the first feedback resource or via a second feedback resource based at least in part on a priority of the second feedback message.

Aspect 24: The method of any of aspects 16 through 23, wherein receiving the one or more feedback messages comprises: receiving the one or more feedback messages as a joint feedback codeword that indicates first feedback associated with the first UE and second feedback associated with the second UE.

Aspect 25: The method of any of aspects 16 through 24, wherein receiving the one or more feedback messages comprises: receiving the one or more feedback messages based at least in part on each UE of the plurality of UEs having a capability to share uplink feedback resources to assist uplink feedback reporting based at least in part on being part of the UE group.

Aspect 26: The method of aspect 25, wherein the capability is configured per cell configuration, per bandwidth part configuration, or both.

Aspect 27: The method of any of aspects 16 through 26, further comprising: transmitting an indication of a third set of uplink feedback resources allocated for a third UE, wherein the third set of uplink feedback resources is configured for the uplink feedback resource sharing for UEs based at least in part on the first UE, the second UE, and the third UE being in the UE group, wherein: the one or more feedback messages are transmitted via the third set of uplink feedback resources based at least in part on the third set of uplink feedback resources occurring before both the first set of uplink feedback resources and the second set of uplink feedback resources.

Aspect 28: The method of any of aspects 16 through 27, further comprising: transmitting an indication of one or more resources of the first set of uplink feedback resources or the second set of uplink feedback resources, the one or more resources configured for the uplink feedback resource sharing.

Aspect 29: A first UE for wireless communications, comprising one or more memories storing processor-executable code, and one or more processors coupled with the one or more memories and individually or collectively operable to execute the code to cause the first UE to perform a method of any of aspects 1 through 15.

Aspect 30: A first UE for wireless communications, comprising at least one means for performing a method of any of aspects 1 through 15.

Aspect 31: A non-transitory computer-readable medium storing code for wireless communications, the code comprising instructions executable by a processor to perform a method of any of aspects 1 through 15.

Aspect 32: A network entity for wireless communications, comprising one or more memories storing processor-executable code, and one or more processors coupled with the one or more memories and individually or collectively operable to execute the code to cause the network entity to perform a method of any of aspects 16 through 28.

Aspect 33: A network entity for wireless communications, comprising at least one means for performing a method of any of aspects 16 through 28.

Aspect 34: A non-transitory computer-readable medium storing code for wireless communications, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “set” refers to a non-empty set of one or more elements unless expressly stated otherwise.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
one or more processors; and
instructions stored in one or more memories and executable by the one or more processors, individually or collectively, to cause the apparatus to:
communicate an indication that the first UE is in a UE group associated with uplink feedback resource sharing, the UE group comprising a plurality of UEs including the first UE and a second UE;
receive one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE both being in the UE group; and
transmit one or more feedback messages associated with the UE group based at least in part on a selection of a set of shared resources from the first set of uplink feedback resources or the second set of uplink feedback resources.

2. The apparatus of claim 1, wherein, to transmit the one or more feedback messages, the instructions are further executable by the one or more processors, individually or collectively, to cause the apparatus to:
transmit the one or more feedback messages via the second set of uplink feedback resources allocated for the second UE based at least in part on the first UE and the second UE both being in the UE group.

3. The apparatus of claim 1, wherein the instructions are further executable by the one or more processors, individually or collectively, to cause the apparatus to:
receive, from the second UE, a second feedback message comprising feedback associated with the second UE, wherein the one or more feedback messages associated with the UE group comprise the feedback associated with the second UE.

4. The apparatus of claim 1, wherein, to transmit the one or more feedback messages, the instructions are further executable by the one or more processors, individually or collectively, to cause the apparatus to:
transmit the one or more feedback messages to the second UE, wherein the one or more feedback messages comprise feedback associated with the first UE.

5. The apparatus of claim 1, wherein, to receive the one or more messages, the instructions are further executable by the one or more processors, individually or collectively, to cause the apparatus to:
receive an indication of a plurality of sets of feedback resources comprising respective resources for each of the plurality of UEs of the UE group, wherein the plurality of sets of feedback resources are configured for the uplink feedback resource sharing.

6. The apparatus of claim 1, wherein the instructions are further executable by the one or more processors, individually or collectively, to cause the apparatus to:
receive, from the second UE, an indication of the second set of uplink feedback resources that are configured for the uplink feedback resource sharing for the first UE and the second UE; and
transmit, to a network entity, an indication of the uplink feedback resource sharing for the plurality of UEs of the UE group.

7. The apparatus of claim 1, wherein, to communicate the indication that the first UE is in the UE group, the instructions are further executable by the one or more processors, individually or collectively, to cause the apparatus to:
receive, from one or more UEs of the plurality of UEs of the UE group, one or more UE identifiers; and
transmit, to a network entity, an indication of the one or more UE identifiers associated with the plurality of UEs in the UE group.

8. The apparatus of claim 1, wherein the instructions are further executable by the one or more processors, individually or collectively, to cause the apparatus to:
receive, via one or more control messages, an indication of activation or deactivation of the uplink feedback resource sharing for the plurality of UEs in the UE group, wherein the one or more control messages comprise one or more radio resource control messages, one or more medium access control-control elements, one or more downlink control information messages, or any combination thereof.

9. The apparatus of claim 1, wherein, to transmit the one or more feedback messages, the instructions are further executable by the one or more processors, individually or collectively, to cause the apparatus to:
transmit a first feedback message of the one or more feedback messages associated with the first UE via a first feedback resource; and
transmit a second feedback message of the one or more feedback messages associated with the second UE via the first feedback resource or via a second feedback resource based at least in part on a priority of the second feedback message.

10. The apparatus of claim 1, wherein, to transmit the one or more feedback messages, the instructions are further executable by the one or more processors, individually or collectively, to cause the apparatus to:
transmit the one or more feedback messages as a joint feedback codeword that indicates first feedback associated with the first UE and second feedback associated with the second UE.

11. The apparatus of claim 1, wherein, to transmit the one or more feedback messages, the instructions are further executable by the one or more processors, individually or collectively, to cause the apparatus to:
transmit the one or more feedback messages via the first set of uplink feedback resources based at least in part on the first set of uplink feedback resources occurring a threshold duration of time before the second set of uplink feedback resources or via the second set of uplink feedback resources based at least in part on the second set of uplink feedback resources occurring the threshold duration of time before the second set of uplink feedback resources.

12. The apparatus of claim 1, wherein each UE of the plurality of UEs has a capability to share uplink feedback resources to assist uplink feedback reporting based at least in part on each UE being in the UE group.

13. The apparatus of claim 12, wherein the capability is configured per cell configuration, per bandwidth part configuration, or both.

14. The apparatus of claim 1, wherein the instructions are further executable by the one or more processors, individually or collectively, to cause the apparatus to:
receive an indication of a third set of uplink feedback resources allocated for a third UE, wherein the third set of uplink feedback resources is configured for the uplink feedback resource sharing for UEs based at least in part on the first UE, the second UE, and the third UE being in the UE group, wherein the one or more feedback messages are transmitted via the third set of uplink feedback resources based at least in part on the third set of uplink feedback resources occurring before both the first set of uplink feedback resources and the second set of uplink feedback resources.

15. The apparatus of claim 1, wherein the instructions are further executable by the one or more processors, individually or collectively, to cause the apparatus to:
receive an indication of one or more resources of the first set of uplink feedback resources or the second set of uplink feedback resources, the one or more resources configured for the uplink feedback resource sharing.

16. An apparatus for wireless communications at a network entity, comprising:
one or more processors; and
instructions stored in one or more memories and executable by the one or more processors, individually or collectively, to cause the apparatus to:
communicate an indication that a first UE is associated with a UE group associated with uplink feedback resource sharing, the UE group comprising a plurality of UEs including the first UE and a second UE;
transmit one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE being part of the UE group; and
receive one or more feedback messages associated with the UE group based at least in part on the uplink feedback resource sharing.

17. The apparatus of claim 16, wherein the instructions are further executable by the one or more processors, individually or collectively, to cause the apparatus to:
receive, from the first UE, a second feedback message comprising feedback associated with the second UE, wherein the one or more feedback messages associated with the UE group comprise the feedback associated with the second UE.

18. The apparatus of claim 16, wherein, to receive the one or more feedback messages, the instructions are further executable by the one or more processors, individually or collectively, to cause the apparatus to:
receive, from the first UE and via the first set of uplink feedback resources allocated for the first UE, the one or more feedback messages associated with the second UE.

19. The apparatus of claim 16, wherein, to transmit the one or more messages, the instructions are further executable by the one or more processors, individually or collectively, to cause the apparatus to:
transmit an indication of a plurality of sets of feedback resources comprising respective resources for each of the plurality of UEs of the UE group, wherein the plurality of sets of feedback resources are configured for the uplink feedback resource sharing.

20. The apparatus of claim 16, wherein the instructions are further executable by the one or more processors, individually or collectively, to cause the apparatus to:
receive an indication of the uplink feedback resource sharing for the plurality of UEs of the UE group.

21. The apparatus of claim 16, wherein, to communicate the indication that the first UE is in the UE group, the instructions are further executable by the one or more processors, individually or collectively, to cause the apparatus to:
receive one or more UE identifiers associated with the plurality of UEs in the UE group.

22. The apparatus of claim 16, wherein the instructions are further executable by the one or more processors, individually or collectively, to cause the apparatus to:
transmit, via one or more control messages, an indication of activation or deactivation of the uplink feedback resource sharing for the plurality of UEs in the UE group, wherein the one or more control messages comprise one or more radio resource control messages, one or more medium access control-control elements, one or more downlink control information messages, or any combination thereof.

23. The apparatus of claim 16, wherein, to receive the one or more feedback messages, the instructions are further executable by the one or more processors, individually or collectively, to cause the apparatus to:
receive a first feedback message of the one or more feedback messages associated with the first UE via a first feedback resource; and
receive a second feedback message of the one or more feedback messages associated with the second UE via the first feedback resource or via a second feedback resource based at least in part on a priority of the second feedback message.

24. The apparatus of claim 16, wherein, to receive the one or more feedback messages, the instructions are further executable by the one or more processors, individually or collectively, to cause the apparatus to:
receive the one or more feedback messages as a joint feedback codeword that indicates first feedback associated with the first UE and second feedback associated with the second UE.

25. The apparatus of claim 16, wherein, to receive the one or more feedback messages, the instructions are further executable by the one or more processors, individually or collectively, to cause the apparatus to:
receive the one or more feedback messages based at least in part on each UE of the plurality of UEs having a capability to share uplink feedback resources to assist uplink feedback reporting based at least in part on being part of the UE group.

26. The apparatus of claim 25, wherein the capability is configured per cell configuration, per bandwidth part configuration, or both.

27. The apparatus of claim 16, wherein the instructions are further executable by the one or more processors, individually or collectively, to cause the apparatus to:
transmit an indication of a third set of uplink feedback resources allocated for a third UE, wherein the third set of uplink feedback resources is configured for the uplink feedback resource sharing for UEs based at least in part on the first UE, the second UE, and the third UE being in the UE group, wherein:
the one or more feedback messages be transmitted via the third set of uplink feedback resources based at least in part on the third set of uplink feedback resources occurring before both the first set of uplink feedback resources and the second set of uplink feedback resources.

28. The apparatus of claim 16, wherein the instructions are further executable by the one or more processors, individually or collectively, to cause the apparatus to:
transmit an indication of one or more resources of the first set of uplink feedback resources or the second set of uplink feedback resources, the one or more resources configured for the uplink feedback resource sharing.

29. A method for wireless communications at a first user equipment (UE), comprising:
communicating an indication that the first UE is in a UE group associated with uplink feedback resource sharing, the UE group comprising a plurality of UEs including the first UE and a second UE;
receiving one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE both being in the UE group; and
transmitting one or more feedback messages associated with the UE group based at least in part on a selection of a set of shared resources from the first set of uplink feedback resources or the second set of uplink feedback resources.

30. A method for wireless communications at a network entity, comprising:
communicating an indication that a first UE is associated with a UE group associated with uplink feedback resource sharing, the UE group comprising a plurality of UEs including the first UE and a second UE;
transmitting one or more messages indicating a first set of uplink feedback resources allocated for the first UE and indicating a second set of uplink feedback resources allocated for the second UE, wherein the first set of uplink feedback resources and the second set of uplink feedback resources are configured for the uplink feedback resource sharing for UEs based at least in part on the first UE and the second UE being part of the UE group; and
receiving one or more feedback messages associated with the UE group based at least in part on the uplink feedback resource sharing.
